(19) United States
(12) Patent Application Publication
(10) Pub. No.: US 2005/0080858 A1
(43) Pub. Date: Apr. 14, 2005

(54) System and method for searching a peer-to-peer network

(75) Inventor: Yaniv Pessach, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/684,126

(22) Filed: Oct. 10, 2003

(51) Int. Cl. G06F 15/16

(52) U.S. Cl. 709/206

(57) ABSTRACT

A peer-to-peer (P2P) search request message may multicast from an originating peer to its neighboring peers. Each neighboring peer may multicast the request message in turn until a search radius is reached. Each peer receiving the request message may conduct a single node search. If the single node search is successful, a P2P search response message may be generated. Each receiving peer may filter duplicate messages and may multicast to less than 100% of its neighbors. Responses may be cached and cached responses sent in response to request messages, expanding the effective search radius of a given P2P search. The multicast probability for a neighbor may be a function of how frequently the neighbor has previously responded to a particular search type. To reduce abuse by impolite or malicious peers, in addition to rate-based throttling, originating peers may be required to solve a computationally expensive puzzle.

### FIELD OF THE INVENTION

This invention pertains generally to computer networks and, more particularly, to peer-to-peer style computer networking.

### BACKGROUND OF THE INVENTION

Computer networks have become large and widespread, supporting a vast array of applications from multimedia communications to distributed processing. Applications utilize a variety of architectures to take advantage of computer network services. Well known client-server architectures provide one set of examples, peer-to-peer (P2P) architectures provide another. In peer-to-peer architectures, each peer may act as both client and server. The decentralized nature of peer-to-peer architectures may have advantages over client-server architectures, for example, in terms of scalability and reliability, particularly as the number of network participants grows large.

A key service provided by computer networks is the ability for network participants to share resources, for example, databases, files and peripherals such as printers. In client-server architectures, shared resources may be located at a relatively few centralized servers. In peer-to-peer architectures, shared resources may be located at each peer in a large peer-to-peer network. Finding a location of a particular shared resource in a peer-to-peer network may be a challenge, particularly because peer-to-peer networks may assemble in an ad hoc manner, with peers joining and leaving more or less at random.

Some conventional peer-to-peer architectures have included peer resource location mechanisms but they have problems. Some conventional peer resource location mechanisms are inefficient, for example, in terms of bandwidth or processor usage, for example, burdening the peer-to-peer network with excessive search messages or involving an excessive number of peers in a single search. Some conventional peer resource location mechanisms provide inadequate regulation of peer-to-peer network searches enabling abuse of peer-to-peer networks by individual peers, even to the point of denial of service (DoS), for example, by malicious peers. Some conventional peer-to-peer architectures including peer resource location mechanisms are designed for particular applications and lack the flexibility required to support the wide variety of modern applications demanded by computer network users.

### BRIEF SUMMARY OF THE INVENTION

This section presents a simplified summary of some embodiments of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In an embodiment of the invention, a peer-to-peer search request message is formatted, a distributed throttling computational puzzle for the peer-to-peer search request message is solved and the peer-to-peer search request message is sent to at least one receiving peer in a peer-to-peer network. The solution to the distributed throttling computational puzzle may be verified at each peer that receives the peer-to-peer search request message.

In an embodiment of the invention, the peer-to-peer search request message is formatted, and sent to each peer in a multicast set. Peers in the multicast set may be selected from neighboring peers of a sending peer. Each neighboring peer of the sending peer has a peer-to-peer search multicast probability of being included in the multicast set. The peer-to-peer search multicast probability may be a function of the number of neighboring peers of the sending peer.

In an embodiment of the invention, the peer-to-peer search request message is parsed. The peer-to-peer search request message contains a number of data fields. The data fields of the peer-to-peer search request message include a data field that contains a search request message identifier and a data field that contains a search request identifier. The peer-to-peer search request message is discarded if the search request message identifier of the peer-to-peer search request message is in a search request cache. At least one data field of the peer-to-peer search request message is passed to at least one registered application if the search request identifier of the peer-to-peer search request message is not in the search request cache.

In an embodiment of the invention, the peer-to-peer search request message is parsed. It is verified that the distributed throttling computational puzzle for the peer-to-peer search request message is solved. The peer-to-peer search request message is discarded if the distributed throttling computational puzzle for the peer-to-peer search request message is not solved. In an embodiment of the invention, a peer-to-peer search message filter module is configured to discard the peer-to-peer search request message if the peer-to-peer search request message does not include a valid solution to the distributed throttling computational puzzle.

In an embodiment of the invention, a peer-to-peer routing path of the peer-to-peer search request message is updated to include a forwarding peer. For each neighboring peer of the forwarding peer, a forwarding condition is determined to be true or false. The forwarding condition includes that the neighboring peer is not in the peer-to-peer routing path of the peer-to-peer search request message. The peer-to-peer search request message is forwarded to the neighboring peer if the forwarding condition is true for that neighboring peer.

In an embodiment of the invention, a peer-to-peer search response message is generated in response to the peer-to-peer search request message. The peer-to-peer search request message has a peer-to-peer routing path. The peer-to-peer routing path lists, in order, peers in the peer-to-peer network traversed by the peer-to-peer search request message, beginning with the peer that originated the peer-to-peer search. When sending or forwarding, the peer-to-peer search response message is sent from the sending peer to the first peer in the peer-to-peer routing path that is a neighbor of the sending peer.

### BRIEF DESCRIPTION OF THE DRAWINGS

While the appended claims set forth the features of the invention with particularity, the invention and its advantages are best understood from the following detailed description taken in conjunction with the accompanying drawings, of which:

FIG. 1 is a schematic diagram illustrating computers connected by a data transport network;

FIG. 2 is a schematic diagram generally illustrating an exemplary computer system usable to implement an embodiment of the invention;

FIG. 3 is a schematic diagram depicting an example peer-to-peer network in accordance with an embodiment of the invention;

FIG. 4 is a block diagram illustrating an example high-level peer-to-peer architectural environment in accordance with an embodiment of the invention;

FIG. 5 is a block diagram illustrating an example modular software architecture suitable for implementing a peer-to-peer search component in accordance with an embodiment of the invention;

FIG. 6 is a block diagram illustrating an example peer-to-peer search request message in accordance with an embodiment of the invention;

FIG. 7 is a block diagram illustrating an example peer-to-peer search response message in accordance with an embodiment of the invention;

FIG. 8 is a schematic diagram depicting a relatively simple example peer-to-peer search with a search radius of two in accordance with an embodiment of the invention;

FIG. 9 is a schematic diagram depicting an example peer-to-peer search in accordance with an embodiment of the invention that extends the example depicted in FIG. 8 by incorporating duplicate filtering mechanisms and having a larger search radius;

FIG. 10 is a schematic diagram depicting an example peer-to-peer search response path in accordance with an embodiment of the invention;

FIG. 11 is a schematic diagram depicting example peer-to-peer search response paths in accordance with an embodiment of the invention and extending the example depicted in FIG. 9;

FIG. 12 is a schematic diagram depicting an example peer-to-peer search in accordance with an embodiment of the invention that takes place after the example depicted in FIG. 11;

FIG. 13 is a schematic diagram depicting, in accordance with an embodiment of the invention, example cached and non-cached responses to the example peer-to-peer search request messages depicted in FIG. 12;

FIG. 14 is a schematic diagram depicting an example peer-to-peer search in accordance with an embodiment of the invention that incorporates probabilistic multicast;

FIG. 15 is a flowchart depicting example steps for sending peer-to-peer search request messages from an originating peer in accordance with an embodiment of the invention;

FIG. 16 is a flowchart depicting example steps for solving a distributed throttling computational puzzle for a particular peer-to-peer search request message in accordance with an embodiment of the invention;

FIG. 17 is a first part of a flowchart depicting example steps for filtering incoming peer-to-peer search request messages in accordance with an embodiment of the invention;

FIG. 18 is a second part of a flowchart depicting example steps for filtering incoming peer-to-peer search request messages in accordance with an embodiment of the invention;

FIG. 19 is a flowchart depicting example steps for verifying that a distributed throttling computational puzzle was solved for a particular peer-to-peer search request message in accordance with an embodiment of the invention;

FIG. 20 is a flowchart depicting example steps for passing incoming peer-to-peer search requests to registered applications in accordance with an embodiment of the invention;

FIG. 21 is a first part of a flowchart depicting example steps for forwarding peer-to-peer search request messages in accordance with an embodiment of the invention;

FIG. 22 is a second part of a flowchart depicting example steps for forwarding peer-to-peer search request messages in accordance with an embodiment of the invention;

FIG. 23 is a flowchart depicting example steps for routing peer-to-peer search response messages FIG. 21 is a flowchart depicting example steps for forwarding peer-to-peer search request messages in accordance with an embodiment of the invention; and

FIG. 24 is a flowchart depicting example steps for processing received peer-to-peer search response messages in accordance with an embodiment of the invention.

### DETAILED DESCRIPTION OF THE INVENTION

Prior to proceeding with a description of the various embodiments of the invention, a description of a computer and networking environment in which the various embodiments of the invention may be practiced is now provided. Although not required, the invention will be described in the general context of computer-executable instructions, such as program modules, being executed by a computer. Generally, programs include routines, objects, components, data structures and the like that perform particular tasks or implement particular abstract data types. The term “program” as used herein may connote a single program module or multiple program modules acting in concert. The terms “computer” and “computing device” as used herein include any device that electronically executes one or more programs, such as personal computers (PCs), hand-held devices, multi-processor systems, microprocessor-based programmable consumer electronics, network PCs, minicomputers, tablet PCs, laptop computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

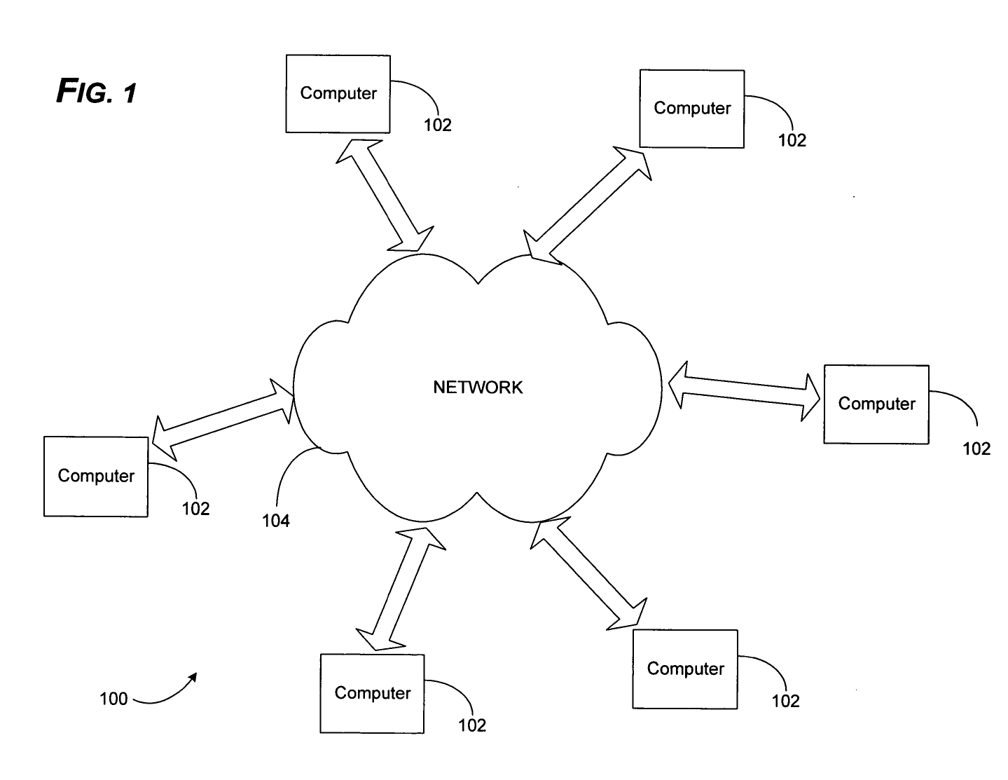

An example of a computer networking environment suitable for incorporating aspects of the invention is described with reference to FIG. 1. The example computer networking environment 100 includes several computers 102 communicating with one another over a data transport network 104, represented by a cloud. Data transport network 104 may include many well-known components, such as routers, gateways, hubs, etc. and allows the computers 102 to communicate via wired and/or wireless media. When interacting with one another over the data transport network 104, one or more of the computers 102 may act as clients, servers or peers with respect to other computers 102. Accordingly, the various embodiments of the invention may be practiced on clients, servers, peers or combinations thereof, even though specific examples contained herein may not refer to all of these types of computers.

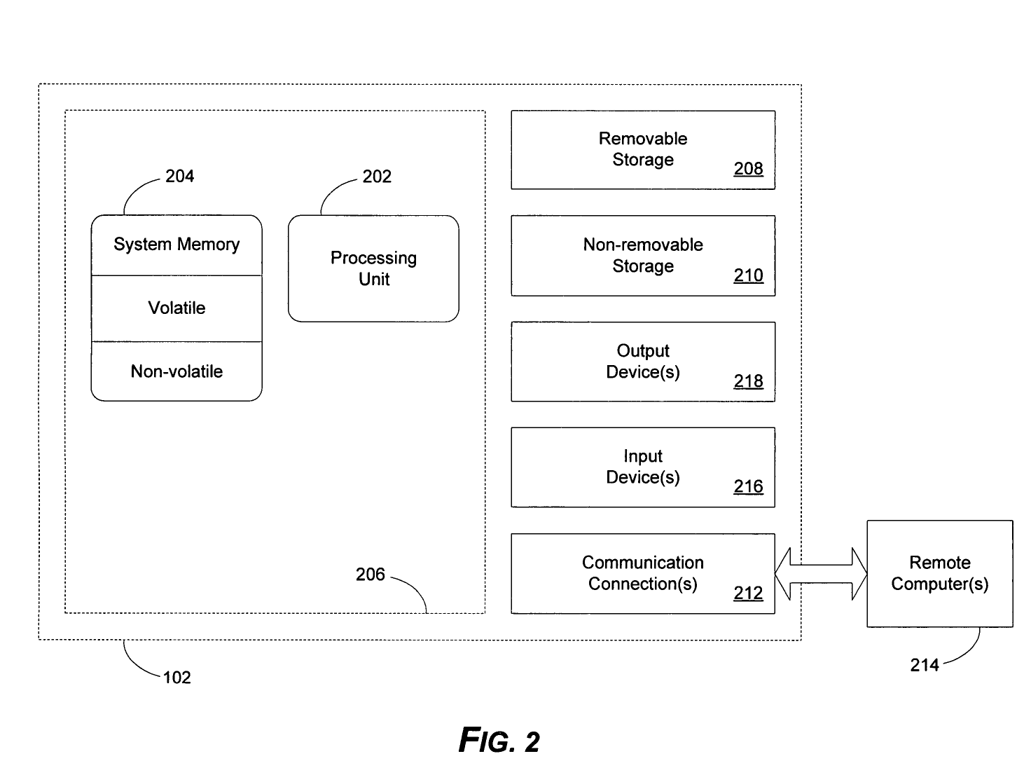

Referring to FIG. 2, an example of a basic configuration for the computer 102 on which aspects of the invention described herein may be implemented is shown. In its most basic configuration, the computer 102 typically includes at least one processing unit 202 and memory 204. The processing unit 202 executes instructions to carry out tasks in accordance with various embodiments of the invention. In carrying out such tasks, the processing unit 202 may transmit electronic signals to other parts of the computer 102 and to devices outside of the computer 102 to cause some result. Depending on the exact configuration and type of the computer 102, the memory 204 may be volatile (such as RAM), non-volatile (such as ROM or flash memory) or some combination of the two. This most basic configuration is illustrated in FIG. 2 by dashed line 206.

The computer 102 may also have additional features/functionality. For example, computer 102 may also include additional storage (removable 208 and/or non-removable 210) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 102. Any such computer storage media may be part of computer 102.

The computer 102 preferably also contains communications connections 212 that allow the device to communicate with other devices such as remote computer(s) 214. A communication connection is an example of a communication medium. Communication media typically embody computer readable instructions, data structures, program modules or other data in a modulated data signal such as a carrier wave or other transport mechanism and includes any information delivery media. By way of example, and not limitation, the term “communication media” includes wireless media such as acoustic, RF, infrared and other wireless media. The term “computer-readable medium” as used herein includes both computer storage media and communication media.

The computer 102 may also have input devices 216 such as a keyboard/keypad, mouse, pen, voice input device, touch input device, etc. Output devices 218 such as a display, speakers, a printer, etc. may also be included. All these devices are well known in the art and need not be described at length here.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

Some peer-to-peer architectural features will help place the following description in context. Peer-to-peer architectures are known in the art so only some of their features are highlighted here. Each peer in a peer-to-peer network may communicate with any other peer in the peer-to-peer network either directly or indirectly. Peers communicate directly if they are able to communicate over a single peer-to-peer network hop (i.e., peer-to-peer network connection) and indirectly if two or more hops are required. The set of peers that a particular peer communicates with directly are that particular peer's neighbors (i.e., neighboring peers).

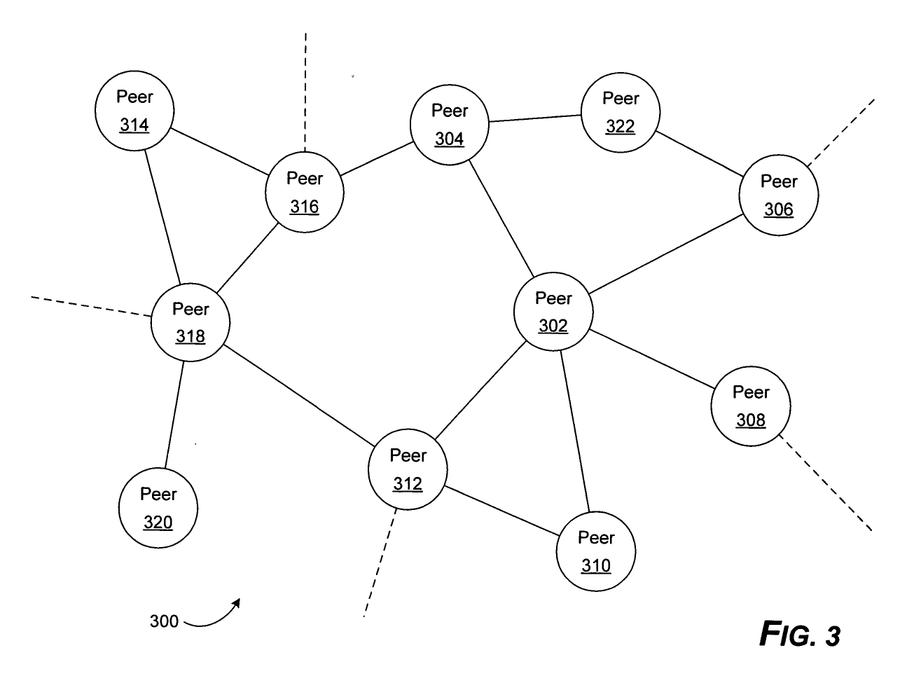

FIG. 3 depicts an example peer-to-peer network in accordance with an embodiment of the invention. Peer-to-peer network 300 includes multiple peers 302, 304, 306, 308, 310, 312, 314, 316, 318, 320, 322 able to communicate with each other. Peer 302 may communicate directly with peers 304, 306, 308, 310 and 312, that is, peers 304, 306, 308, 310 and 312 are neighbors of peer 302 in the peer-to-peer network 300. Peer 314 may communicate directly with peers 316 and 318, that is, peers 316 and 318 are neighbors of peer 314 in the peer-to-peer network 300. Peer 320 has a single neighbor in the peer-to-peer network 300, that is, peer 318.

Peer 302 may communicate indirectly with peer 322, for example, over a first peer-to-peer network hop to peer 304 and then over a second peer-to-peer network hop from peer 304 to peer 322. Peer 314 may communicate indirectly with peer 302, for example, over a first hop to peer 316, a second hop from peer 316 to peer 304 and then a third hop from peer 304 to peer 302. Multiple communication paths may exist between peers, for example, in the peer-to-peer network 300, peer 302 may also communicate with peer 322 over a first hop to peer 306 and then over a second hop to peer 322. Peers 306, 308, 312, 316 and 318 have dashed lines leaving them that indicate connections to peers in the peer-to-peer network 300 that are not shown in FIG. 3.

A single computer may support more than one peer, for example, peer 310 and peer 312 may be supported by one of the computers 102 (FIG. 1). A single peer may be supported by more than one computer, for example, peer 302 may be supported by a cluster of computers 102. Peer-to-peer network connections may be supported by an underlying data transport network, for example, the data transport network 104 of FIG. 1. However, peer-to-peer network topology may be independent of the topology of the underlying data transport network. A single peer-to-peer network connection may be supported by more than one data transport network link, and more than one peer-to-peer network connection may be supported by a single data transport network link. For example, the peer-to-peer network connection between peer 302 and peer 304 may be supported by three data transport network links: a Transport Control Protocol (TCP) and Internet Protocol version 4 (IPv4) link over wireless, a TCP and Internet Protocol version 6 (IPv6) link over optical fiber, and then a TCP and IPv4 link over copper. The peer-to-peer network connection between peer 310 and peer 312 may ultimately be implemented as a memory copy or shared memory on a single computer.

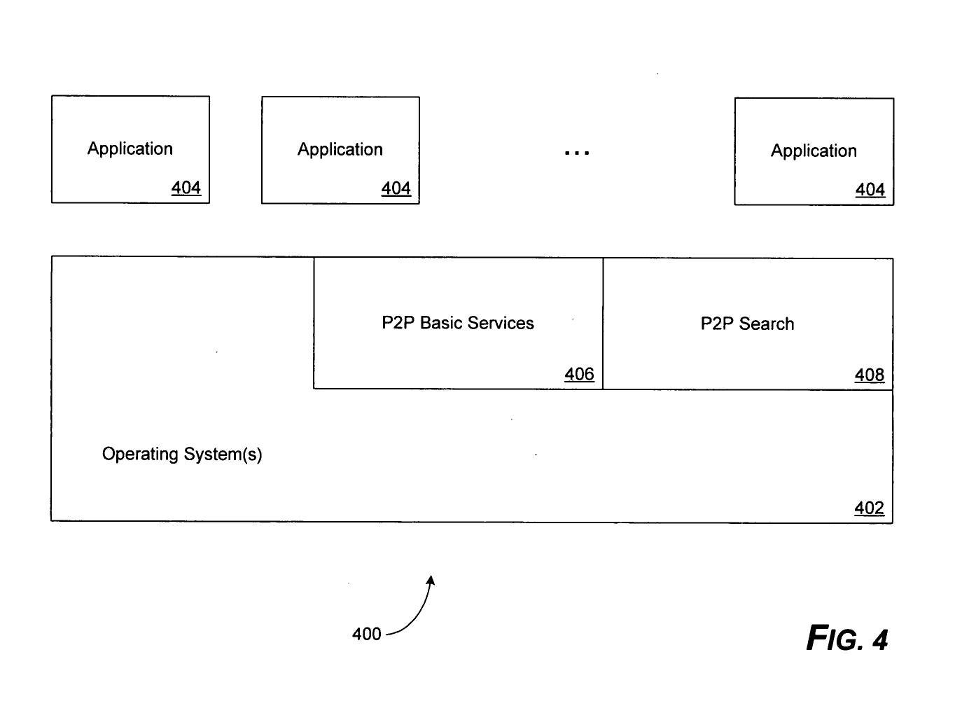

FIG. 4 depicts an example high-level peer-to-peer architectural environment in accordance with an embodiment of the invention. The peer-to-peer architectural environment 400 includes one or more computer operating systems 402 such as Microsoft® Windows® and UNIX®, as well as multiple applications 404 that may utilize peer-to-peer functionality. In the example peer-to-peer architectural environment 400, peer-to-peer (P2P) basic services 406 are implemented independently of peer-to-peer (P2P) search component 408 functionality. Peer-to-peer search component 408 functionality may be incorporated into peer-to-peer basic services 406. Peer-to-peer basic services 406 may be incorporated into one or more operating systems 402. Applications 404 may take advantage of peer-to-peer basic services 406 and peer-to-peer search component 408 functionality in the same way(s) they take advantage of operating system 402 functionality.

A suitable peer-to-peer basic services 406 implementation is described in U.S. patent application Ser. No. 09/955,923, entitled Peer-to-Peer Group Management and Method for Maintaining Peer-to-Peer Graphs, filed on Sep. 19, 2001. Briefly, peer-to-peer basic services 406 include establishing and maintaining the peer-to-peer network (e.g., the peer-to-peer network 300 of FIG. 3), which in turn includes, for example, generating and assigning peer identifiers to peers, establishing peer-to-peer network connections between peers, and establishing a graph time that is the same for each peer in a given peer-to-peer network graph. Each peer in the peer-to-peer network 300 may have access to peer-to-peer basic services 406 and peer-to-peer search component 408 functionality.

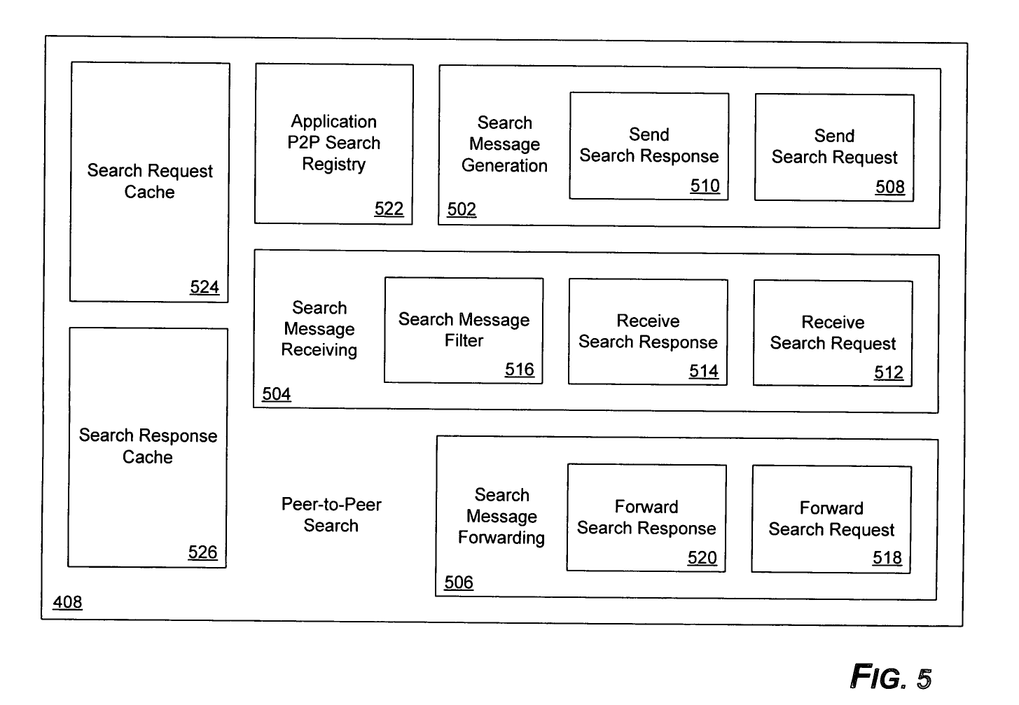

FIG. 5 depicts an example modular software architecture suitable for implementing peer-to-peer search component 408. In the example depicted in FIG. 5, the peer-to-peer search component 408 includes a search message generation module 502, a search message receiving module 504, and a search message forwarding module 506. The search message generation module 502 includes a send search request module 508 and a send search response module 510. The search message receiving module 504 includes a receive search request module 512, a receive search response module 514, and a search message filter module 516. The search message forwarding module 506 includes a forward search request module 518 and a forward search response module 520. The peer-to-peer search component 408 further includes an application peer-to-peer search registry 522, a search request cache 524, and a search response cache 526. Each of these modules is described in more detail below.

At a high level, a peer-to-peer search in accordance with an embodiment of the invention involves propagating a peer-to-peer search request message outward through the peer-to-peer network from an originating peer (i.e., the peer where the search originates), executing a conventional single node search at each peer that receives the peer-to-peer search request message, and, if any of the single node searches are successful, propagating peer-to-peer search response messages back through the peer-to-peer network from responding peers (i.e., peers where the single node search was successful) to the originating peer. In the description that follows, it will be helpful to have reference to an example peer-to-peer search request message and an example peer-to-peer search response message.

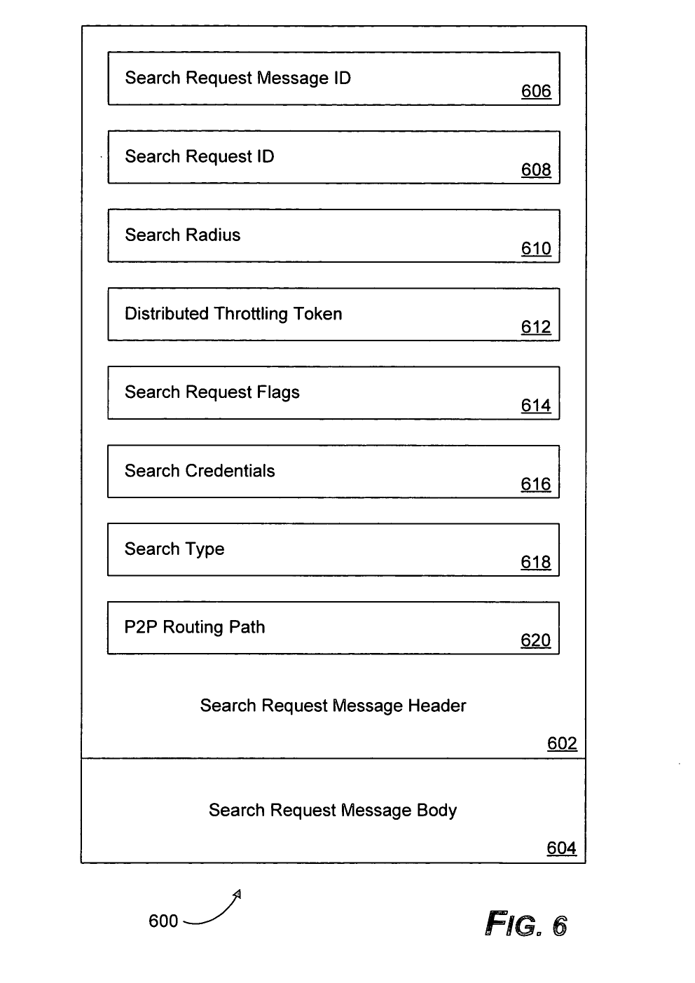

FIG. 6 depicts an example peer-to-peer search request message in accordance with an embodiment of the invention. A peer-to-peer search request message 600 includes a search request message header 602 and a search request message body 604. The search request message header 602 includes a search request message identifier (ID) field 606 containing, for example, a 16-byte globally unique identifier (GUID) uniquely identifying the peer-to-peer search request message 600. The search request message header 602 also includes a search request ID field 608 containing, for example, a 16-byte GUID that uniquely identifies the peer-to-peer search associated with the peer-to-peer search request message 600.

The search request message header 602 further includes a search radius field 610, a distributed throttling token 612, a search request flags field 614, a search credentials field 616, a search type field 618, and a peer-to-peer (P2P) routing path field 620. Each of these fields is described in more detail below. The search request message body 604 contains application-specific search fields, for example, a conjunction of predicates on application-specific variables, a sentence of structured query language (SQL), or the like. Instead of, or in addition to, the search type field 618, each search field in the search request message body 604 may incorporate, or be associated with, its own search type field (not shown in FIG. 6).

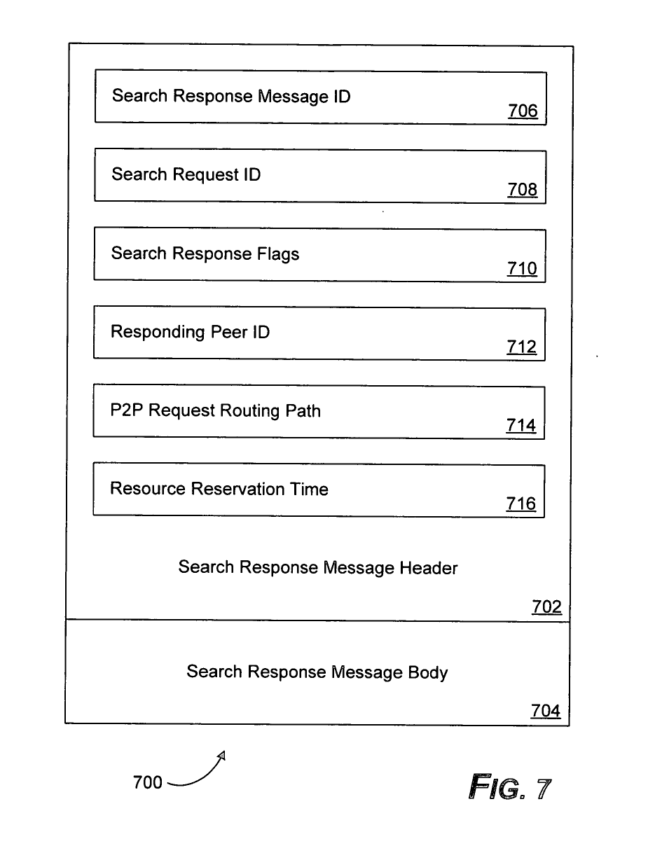

FIG. 7 depicts an example peer-to-peer search response message in accordance with an embodiment of the invention. A peer-to-peer search response message 700 includes a search response message header 702 and a search request message body 704. The search response message header 702 includes a search response message ID field 706 containing, for example, a 16-byte GUID that uniquely identifies the peer-to-peer search response message 700. The search response message header 702 also includes a search request ID field 708 containing, for example, a 16-byte GUID that uniquely identifies the peer-to-peer search associated with the peer-to-peer search response message 700.

The search response message header 702 further includes a search response flags field 710, a responding peer ID field 712, a peer-to-peer request routing path field 714 and a resource reservation time field 716. Each of these fields is described in more detail below. The search response message body 704 contains application-specific search response fields, for example, extensible markup language (XML) encoded resource specification objects. Instead of, or in addition to, the resource reservation time field 716, each search response field in the search response message body 704 may incorporate, or be associated with, its own resource reservation time field (not shown in FIG. 7).

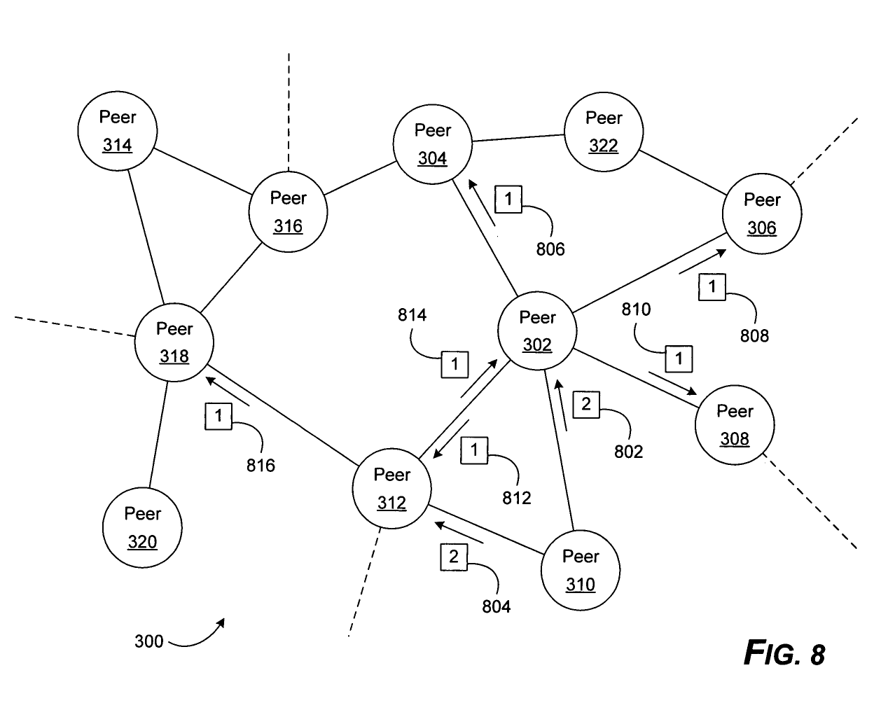

A peer-to-peer search in accordance with an embodiment of the invention may take advantage of one or more features described below. Each feature described below need not be present in an embodiment of the invention. For clarity, and to provide context, a relatively simple example incorporating some features is first described with reference to FIG. 8. Additional features are described following the simple example.

FIG. 8 depicts an example peer-to-peer search originating at peer 310 with a peer-to-peer search radius of 2. In FIG. 8, peer 310 generates the peer-to-peer search request message 600 (FIG. 6) and sends copies of the message 600 to each of its neighbors, i.e., peer 302 and peer 312. The peer-to-peer search request message 600 may be generated as a result of a request to initiate the example peer-to-peer search by one of the applications 404 of FIG. 4. As part of generating the peer-to-peer search request message 600, peer 310 sets the search radius field 610 of the message 600 to the value 2 and adds itself as the first (originating) peer in the peer-to-peer routing path field 620. The small blocks with the number 2 inside them represent copies of the peer-to-peer search request message 600 with a search radius field 610 value of 2 being sent from peer 310 to peer 302 (i.e., peer-to-peer search request message 802) and from peer 310 to peer 312 (i.e., peer-to-peer search request message 804). The generation and sending of the peer-to-peer search request message 600 may be performed by the send search request module 508 of FIG. 5.

Peer 302 receives the peer-to-peer search request message 802 and parses it for its various data fields. The receiving and parsing of the peer-to-peer search request message 802 may be performed by the receive search request module 512 (FIG. 5). The contents of the application-specific search fields of the search request message body 604 may be passed to interested applications 404 (FIG. 4). The search request may be passed to interested (i.e., registered) applications 404 by the application peer-to-peer search registry 522. The applications 404 perform the single node (peer) search and, if the single node search is successful, the applications 404 respond with the single node search results. Before describing responding in more detail, the description continues with the propagation of the peer-to-peer search request message 802.

At the same time that interested applications 404 are being informed of the arrival of the peer-to-peer search request message 802, peer 302 acts to forward copies of the message 802 to its neighbors. Peer 302 decrements the search radius field 610 (FIG. 6) of the message 802 so that the value of the field 610 is 1. If the value of the field 610 was zero, the message 802 would not be forwarded by peer 302. If the value of the field 610 was zero, the message 802 would have reached its desired search radius in the peer-to-peer network 300. However, the value of the field 610 is greater than zero, so the peer 302 adds itself as the second (next) peer in the peer-to-peer routing path field 620 and sends copies of the modified message 802 to those of its neighboring peers that have not been added to the peer-to-peer routing path field 620 of the modified message 802. In FIG. 8, the neighbors of peer 302 are peers 304, 306, 308, 310 and 312. Peer 310 has been added to the peer-to-peer routing path field 620 of the modified message 802, so copies of the message 802 are sent to peers 304, 306, 308 and 312, that is, peer-to-peer search request messages 806, 808, 810 and 812, respectively. Each peer-to-peer search request message 806, 808, 810 and 812 is labeled with a 1 to indicate that their search radius field 610 has a value of 1.

Before peer 312 receives the peer-to-peer search request message 812 from peer 302, peer 312 receives the peer-to-peer search request message 804 from peer 310. This is not necessarily the case, peer-to-peer message arrival order may, for example, depend upon peer-to-peer network connection speeds and peer processing speeds. When peer 312 receives the message 804 from peer 310, it behaves similarly to peer 302 as when peer 302 received message 802 from peer 310. That is, when peer 312 receives message 804, message 804 is parsed and passed to interested applications, and, at the same time, peer 312 acts to forward message 804 to its neighbors. Peer 312 decrements the search radius field 610 (FIG. 6) value of message 804 to 1 and adds itself to the routing path field 620. Of the neighbors of peer 312, peer 302 and peer 318 have not been added to the routing path field 620 of the modified message 804. As a result, peer 312 sends peer-to-peer search request message 814 to peer 302 and peer-to-peer search request message 816 to peer 318. Peer 312 may also send a copy of the peer-to-peer search request message 804 to a peer at the other end of the dashed line leaving peer 312, however, for clarity, this description will limit itself to peers that are visible in the figure.

When peer 304 receives peer-to-peer search request message 806 from peer 302, the message 806 is parsed and may be passed to interested applications as described above (various mechanisms for discarding duplicate and/or otherwise undesirable search requests are described in detail below). However, when peer 304 decrements the search radius field 610 (FIG. 6) of the message 806, the value of the search radius field 610 becomes zero. As a result, peer 304 does not forward the message 806 to its neighbors. The message 806 has reached the limit of the peer-to-peer network search radius desired by the originator of the message 806. Similar behavior occurs at other peers that receive a copy of the peer-to-peer search request message with the search radius field 610 value set to 1. The search radius field 610 value helps limit the number of peers in the peer-to-peer network 300 that participate in the peer-to-peer search initiated by peer 310. Although in this example the search radius field 610 value is decremented from a high number to a lower number, as will be apparent to one of skill in the art, equivalent schemes may be utilized by an embodiment of the invention, for example, incrementing the search radius field 610 value from a low number (e.g., 1 or 0) to a higher number, or leaving the initial value of the search radius field 610 unchanged and forwarding the message until the number of peers that have been added to the peer-to-peer routing path field 620 is equal to that value. In an embodiment of the invention, the initial peer-to-peer search radius value indicates the maximum number of peers that may be added to the peer-to-peer routing path of the request message 600.

The peer-to-peer routing path field 620 (FIG. 6) helps limit the number of peers in the peer-to-peer network 300 that are sent a copy of the same peer-to-peer search request message originated by peer 310. Although, as this example shows, the peer-to-peer routing path field 620 by itself does not prevent peers from receiving more than one copy of the same peer-to-peer search request message. Peer 302 receives the copy 802 from peer 310 and the copy 814 from peer 312. Peer 312 receives the copy 804 from peer 310 and the copy 812 from peer 302. The peer-to-peer routing path field 620 may contain the peer ID for each peer that is added to the field 620, for example, implemented as a variable size array. Instead of adding the originating peer 310 to the peer-to-peer routing path field 620, the search request message header 602 may incorporate an additional field specifically for containing the peer ID of the originating peer.

The peer-to-peer routing path field 620 (FIG. 6) is also helpful when responding to the peer-to-peer search request message. Each of the peers that receives a copy of the peer-to-peer search request message, i.e., peers 302, 304, 306, 308, 312 and 318 in this example, may respond to the peer-to-peer search originator (i.e., peer 310 in this example) with positive search results. Peers without positive search results should not respond to the peer-to-peer search request message. Responding peers may respond directly to the originating peer, that is, each responding peer may attempt to establish a direct peer-to-peer connection with the originating peer and then send the originating peer the peer-to-peer search response message. For example, if a successful single node search occurred at peer 304 in response to peer-to-peer search request message 806 then peer 304 may attempt to establish a direct peer-to-peer network connection with peer 310 and then send the peer-to-peer search response message to peer 310 across that direct connection (not shown in FIG. 8). However, in an embodiment of the invention, the responding peer propagates the peer-to-peer search response message back through the peer-to-peer network along the peer-to-peer routing path that the corresponding peer-to-peer search request message traveled to arrive at the responding peer.

Continuing the example with reference to FIG. 8: peer-to-peer search request message 806 has traveled from peer 310 to peer 302 and then from peer 302 to peer 304. Peer 310 and peer 302 have been added to the peer-to-peer routing path field 620 of the message 806. The single node search at peer 304 is successful. As a result, peer 304 generates the peer-to-peer search response message 700 (FIG. 7). The search response message ID field 706 may be newly generated (e.g., a new GUID) and different from the search request message ID field 606 of the peer-to-peer search request message 806. The search request ID field 708 corresponds to the search request ID field 608 of the request message 806. The responding peer ID field 712 is set to reference peer 304. The peer-to-peer request routing path field 714 is initialized with the peer-to-peer routing path field 620 of the request message 806. The newly generated peer-to-peer search response message 700 is then sent to the peer that last added itself to the peer-to-peer routing path field 620 of the request message 806. In this example, the newly generated peer-to-peer search response message 700 is sent from peer 304 to peer 302. The generation and sending of the peer-to-peer search response message 700 may be performed by the send search response module 510 of FIG. 5.

At peer 302, the peer-to-peer search response message 700 is received and parsed. The receiving and parsing of the peer-to-peer search response message 700 may be performed by the receive search response module 514 (FIG. 5). Peer 302 may remove itself (e.g., its peer ID) from the peer-to-peer request routing path field 714 to reduce the size of the response message. In an embodiment of the invention, the peer-to-peer request routing path field 714 is forwarded unaltered to the originating peer for analysis and diagnostic purposes. In this example, peer 302 forwards a copy of the peer-to-peer search response message 700 to the next peer closer to the originating peer in the peer-to-peer request routing path field 714, that is, peer 310. The forwarding of the peer-to-peer search response message 700 may be performed by the forward search response module 520.

At peer 310, the peer-to-peer search response message 700 is received and parsed. Peer 310 is the originating peer for the example peer-to-peer search. As a result, the search response fields of the search response message body 704 may be passed to the application 404 (FIG. 4) that initiated the example peer-to-peer search. In an embodiment of the invention, any application 404 aware of a particular peer-to-peer search (e.g., in possession of the associated search request ID) may register interest in results of the particular peer-to-peer search. The results of the peer-to-peer search may be passed to interested (registered) applications 404 by the application peer-to-peer search registry 522. Each peer that receives a copy of the peer-to-peer search request message 600 may respond as described for peer 304.

It is possible for a particular peer in the peer-to-peer network to receive multiple copies of the same peer-to-peer search request message 600. In the example described with reference to FIG. 8, peer 302 received two copies of the peer-to-peer search request message originated by peer 310: copy 802 and copy 814. In an embodiment of the invention, the peer-to-peer search component 408 incorporates one or more duplicate filtering mechanisms, for example, to reduce unnecessary processing of search requests by applications 404 and unnecessary forwarding of peer-to-peer search request messages.

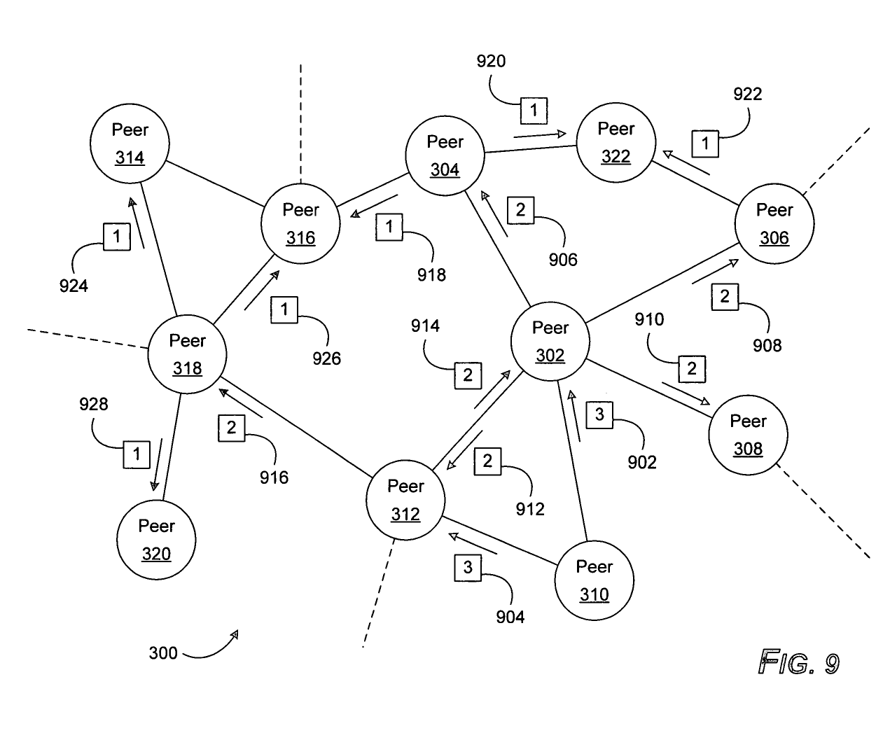

FIG. 9 depicts an example peer-to-peer search in accordance with an embodiment of the invention that originates at peer 310 and has a peer-to-peer search radius of 3. This example extends the example described with reference to FIG. 8 by incorporating duplicate filtering mechanisms and having a larger search radius. As for the example discussed with reference to FIG. 8, peer 310 generates the new peer-to-peer search request message 600 (FIG. 6) and sends copies 902 and 904 to its neighbors peer 302 and peer 312 respectively. In this example the search radius field 610 value of the message 600 is set to 3.

In an embodiment of the invention, a new search request message ID is generated for each new peer-to-peer search request message 600 and the value of the search request message ID field 606 of the message 600 is set to that newly generated ID. Each copy of the peer-to-peer search request message 600 sent by the originating peer that is associated with a particular peer-to-peer search request may have the same search request message ID field 606 value. In addition, each copy of the peer-to-peer search request message 600 forwarded by one of the forwarding peers that is associated with the same peer-to-peer search request may have the same search request message ID field 606 value. For example, each peer-to-peer search request message copy 802, 804, 806, 808, 810, 812, 814, 816 in FIG. 8 has the same search request message ID field 606 value, and each peer-to-peer search request message copy 902, 904, 906, 908, 910, 912, 914, 916, 918, 920, 922, 924, 926, 928 in FIG. 9 has the same search request message ID field 606 value, but the search request message ID field 606 value for the message copies depicted in FIG. 8 and the search request message ID field 606 value for the message copies depicted in FIG. 9 are different. Further, as described in more detail below, a single conceptual peer-to-peer search may include multiple search requests, for example, with increasingly greater search radius. In this case, the search request messages of each search request may have different search request message ID field 606 values because they are a part of separate search request instances but a same search request ID field 608 value because the separate search request instances are part of the same conceptual peer-to-peer search.

In an embodiment of the invention, each peer records search request message IDs of recently received peer-to-peer search request messages in its search request cache 524 (FIG. 5). When the peer receives a new peer-to-peer search request message 600 (FIG. 6), it checks the search request cache 524 for the search request message ID (i.e., the search request message ID field 606 value of the message 600) of the new message 600. If the search request cache 524 contains the search request message ID of the new message 600 then the peer has previously seen a copy of the new message 600 and discards the new message 600. Otherwise the search request message ID of the new message 600 is added to the search request cache 524 and the peer continues processing the message 600.

In the example depicted in FIG. 9, peer 302 receives and parses the peer-to-peer search request message 902. Peer 302 checks its search request cache 524 (FIG. 5) for the search request message ID of message 902. In this example, peer 302 receives peer-to-peer search request message 902 before it receives peer-to-peer search request message 914 from peer 312. As a result, the search request cache 524 of peer 302 does not contain the search request message ID of message 902 at the time that peer 302 receives message 902. Peer 302 adds the search request message ID of message 902 to its search request cache 524 and continues process the message 902. Peer 302 forwards copies 906, 908, 910 and 912 of the message 902 to peers 304, 306, 308 and 312 respectively. This example differs from the example described with reference to FIG. 8 in that the search radius field 610 value of the messages 906, 908, 910 and 912 forwarded by peer 302 is 2 and not 1, that is, the recipients of the messages forwarded by peer 302 will also forward copies to their neighbors.

In this example, peer 312 receives peer-to-peer search request message copy 904 from peer 310 before it receives copy 912 from peer 302. In a similar manner to peer 302, peer 312 receives and parses message 904, checks its search request message cache 524 for the search request message ID of message 904 and, not finding the search request message ID of message 904, peer 312 forwards copies 914 and 916 of the message 904 to peers 302 and 318 respectively.

As for peer 302, this example differs from the example described with reference to FIG. 8 in that the search radius field 610 value of the messages 914 and 916 is 2, that is, it is intended that the recipients of the messages forwarded by peer 312 also forward copies to their neighbors. However, when peer 302 receives peer-to-peer search request message copy 914, peer 302 checks its search request message cache 524 and finds the same search request message ID the search request message ID of message 914. As a result, peer 302 discards peer-to-peer search request message 914. Peer-to-peer search request message 914 does not cause applications 404 (FIG. 4) registered with peer 302 to perform a single node search. Peer-to-peer search request message 914 is not forwarded to neighbors of peer 302. Peer-to-peer search request message 912 is likewise discarded when it arrives at peer 312.

The peer-to-peer search request message copy 906 forwarded to peer 304 is further forwarded to peers 316 and 322 as message copies 918 and 920 respectively. Message copy 908 is forwarded by peer 306 to peer 322 as message copy 922. Message copy 916 is forwarded by peer 318 to peers 314, 316 and 320 as message copies 924, 926 and 928 respectively. Whichever of messages 920 and 922 arrives first at peer 322 is processed by peer 322 (i.e., results in a single node search, etc), the other is discarded. Similarly, whichever of messages 918 and 926 arrives first at peer 316 is processed and the other is discarded. The search radius field 610 value of each of messages 918, 920, 922, 924, 926 and 928 is 1. As a result, messages 918, 920, 922, 924, 926 and 928 are not forwarded by peers 314, 316, 320 and 322.

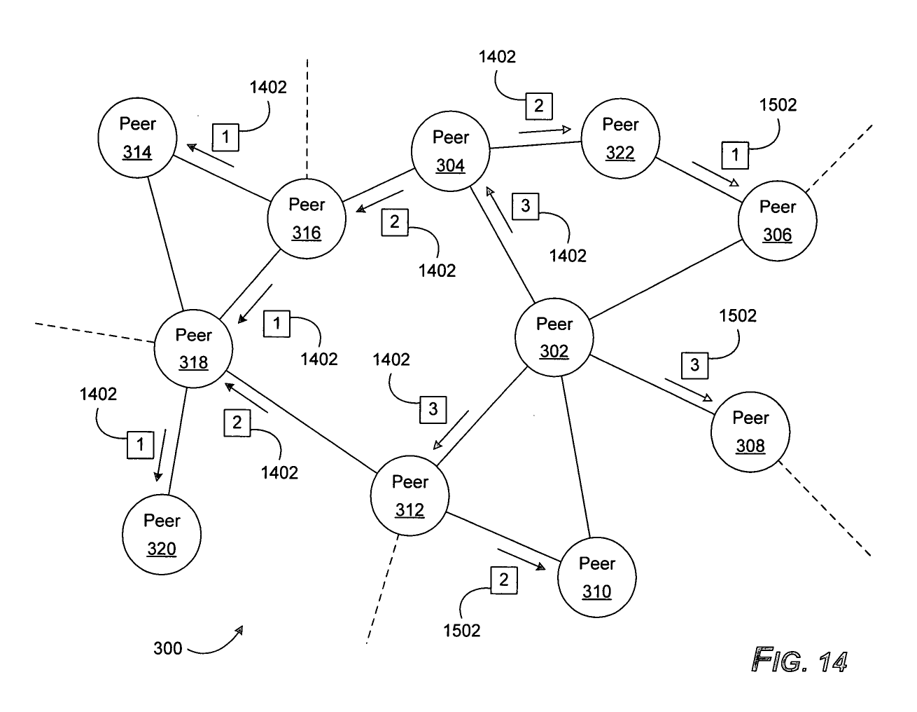

In an embodiment of the invention, in addition to recording search request message IDs in the search request cache 524 (FIG. 5), the peer receiving the peer-to-peer search request message 600 (FIG. 6) also records the peer (e.g., the peer ID) that sent the peer-to-peer search request message 600. This information may be recorded for peer-to-peer search request messages that are discarded as well as for those that are processed. In an embodiment of the invention, each peer that has been added to the peer-to-peer routing path field 620 of the received message may be recorded in the search request cache 524. When determining the set of neighboring peers to which to forward a received peer-to-peer search request message 600 (i.e., the forwarding set), each peer in the search request cache 524 that is associated with the search request message ID of the received peer-to-peer search request message 600 may be eliminated from the forwarding set. This may result in a reduced likelihood of forwarding the message 600 to peers that have already seen a copy. In an embodiment of the invention that incorporates probabilistic multicast, a particular peer's probability of being included in the forwarding set is reduced rather than the peer being simply excluded. In addition, the probability of being included may depend upon redundancy statistics averaged over a number of search requests rather than upon a single search request. See the description with reference to FIG. 14 below for additional details.

With reference to the example depicted in FIG. 9, if peer 302 receives peer-to-peer search request message 902 from peer 302 and, before determining the set of neighboring peers to which to forward the message 902, peer 302 receives peer-to-peer search request message 914 from peer 312 then, in an embodiment of the invention, peer 302 does not forward message 902 to peer 312. In this scenario, when peer 302 receives message 902, the search request message ID and the sender (i.e., peer 310) of message 902 is added to the search request cache 524 (FIG. 5) of peer 302. When peer 302 receives message 914, the search request message ID and the sender (i.e., peer 312) of message 914 is also added to the search request cache 525 of peer 302. In this example the search request message ID of message 914 is the same as the search request message ID of message 902. As a result, the cache 524 entry for message 902 may be updated rather than creating a new cache 524 entry for message 914. When peer 302 determines the set of neighbors to which to forward the message 902, the peers associated with the search request message ID of message 902 in the cache 524, that is, peer 310 and peer 312, may be eliminated from the set. In this scenario, peer-to-peer search request message 912 is not sent from peer 302 to peer 312. Peer-to-peer network 300 bandwidth is saved and peer 312 need not expend even the effort to discard message 912.

The peer-to-peer search example described with reference to FIG. 8 has a peer-to-peer search radius of 2. The peer-to-peer search example described with reference to FIG. 9 has a peer-to-peer search radius of 3. Both example peer-to-peer searches originate at the same peer 310. It may be that the two examples represent two conceptually different peer-to-peer searches, that is, that the search request message body 604 (FIG. 6) incorporates two different sets of application-specific search fields. However, it may be that the two examples represent a repeated peer-to-peer search request that is conceptually part of the same peer-to-peer search, the first with a smaller search radius and the second with a larger search radius but both with search request message bodies incorporating the same set of application-specific search fields. In the case of a repeated peer-to-peer search request with a larger search radius, it may be advantageous to enable propagation of the associated peer-to-peer search request messages without triggering single node searches at those peers that participated in the previous smaller radius search request.

In an embodiment of the invention, each peer-to-peer search request is associated with a search request identifier (ID), e.g., a GUID. Each peer-to-peer search request message 600 may incorporate the search request ID field 608 (containing the search request ID) as well as the search request message ID field 606. Peers receiving the peer-to-peer search request message 600 may record search request ID for the message 600 in the search request cache 524 (FIG. 5) in addition to other data. The repeated peer-to-peer search request may utilize peer-to-peer search request messages with the same search request ID as the earlier peer-to-peer search request but with different search request message IDs and, for example, a larger search radius. When the peer receives the peer-to-peer search request message 600 with a different search request message ID but a same search request ID as previously seen (i.e., that is in the search request cache 524), the message 600 is not discarded. The message 600 may be forwarded but it does not trigger a single node search that would be a duplicate of the single node search triggered by the earlier peer-to-peer search request, for example, with a smaller search radius.

Referring to the examples described with reference to FIG. 8 and FIG. 9. If the example peer-to-peer search request depicted in FIG. 9 is a repeat of the example peer-to-peer search request depicted in FIG. 8 but with a larger search radius then, in an embodiment of the invention, the peer-to-peer search request messages of FIG. 9 do not trigger single node searches at those peers where single node searches were triggered by the peer-to-peer search request messages of FIG. 8, i.e., peers 302, 304, 306, 308, 312 and 318. Single node searches are still triggered at those peers that did not receive peer-to-peer search request messages in the example described with reference to FIG. 8, i.e., peers 314, 316, 320 and 322.

When peer-to-peer search request message 802 is forwarded by peer 302 to peer 304 as message 806, single node searchers are triggered at peers 302 and 304, and peers 302 and 304 record the same search request ID. In this scenario, when peer-to-peer search request message 902 is forwarded by peer 302 to peer 304 as message 906 with the same search request ID as previously seen, peers 302 and 304 forward the messages without triggering a single node search. When message 906 is forwarded to peers 316 and 322 where the search request ID has not previously been seen (i.e., is not in the search request cache 524 of the peer), single node searches are triggered.

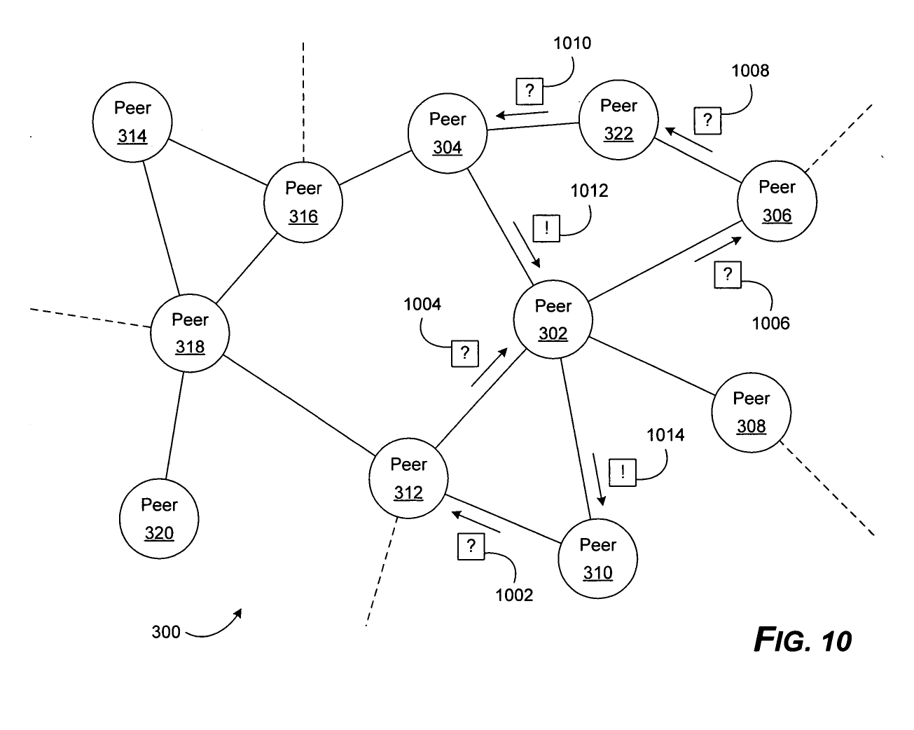

Each peer that forwards the peer-to-peer search request message 600 (FIG. 6) may be added to the peer-to-peer routing path 620 of the message 600. It may be that the peer-to-peer routing path of the peer-to-peer search request message 600 is not the best response path for associated peer-to-peer search response messages. For example, referring to FIG. 10, if a peer-to-peer search request message originating at peer 310 is propagated through the peer-to-peer network 300 as follows: from peer 310 to peer 312, peer 302, peer 306, peer 322 and then to peer 304 (as peer-to-peer search request message copies 1002, 1004, 1006, 1008 and 1010 respectively) where a successful single node search occurs, then response paths exist that are better (e.g., pass through less peers) than a simple reverse path, i.e., from peer 304 to peer 322, peer 306, peer 302, peer 312 and then peer 310. For example, the response path from peer 304 to peer 302 and then peer 310 (utilizing peer-to-peer request response message copies 1012 and 1014 respectively) passes through less peers.

Each peer in the peer-to-peer network 300 may be aware of their neighboring peers but may be otherwise ignorant of peer-to-peer network 300 topology. In addition, peer-to-peer network 300 topology may change between the time the originating peer initiates the peer-to-peer search and the time that the responding peer responds. For example, the peer-to-peer network connections between peers 310 and 302 and between peers 302 and 304 may not have existed when the peer-to-peer search was initiated, or those connections may have been temporarily disabled because of problems in the underlying data transport network. In an embodiment of the invention, the responding peer sends or forwards the peer-to-peer search response message 700 (FIG. 7) to the first peer in the peer-to-peer routing path of the associated peer-to-peer search request message 600 (FIG. 6) with which the peer has an existing direct peer-to-peer network connection.

For example, the peer-to-peer routing path of the peer-to-peer search request message 1010 that is received by peer 304 may be represented by the ordered series: (310, 312, 302, 306, 322). In determining which of its neighbors to send the peer-to-peer search response message generated in response to the request message 1010, peer 304 examines each of the peers in the peer-to-peer routing path in order. Peer 310 and peer 312 are not neighbors of peer 304, but peer 302 is one of the neighbors of peer 304. Peer 304 selects peer 302 to send the response message 1012. Peer 302 acts similarly. In determining which of its neighbors to forward the response message 1012, peer 302 examines each of the peers in the peer-to-peer routing path in order. Peer 310, the first peer examined, is a neighbor of peer 302. Peer 302 selects peer 310 to forward the response message 1014. This shortcut response routing may even improve reliability if one or more of the peer-to-peer network connections on the simple reverse path (e.g., the connection between peers 302 and 312) is missing or disabled. In an embodiment of the invention, each peer may respond by both shortcut response routing and simple reverse path routing, for example, in order to further improve reliability.

In an embodiment of the invention, information about peer-to-peer search responses is cached at peers (response caching peers) that forward peer-to-peer search response messages. When the response caching peer subsequently forwards peer-to-peer search request messages, in addition to any peer-to-peer search response messages containing the results of a triggered single node search (i.e., non-cached responses), the peer may send peer-to-peer search response messages containing cached information relevant to the associated peer-to-peer search (i.e., cached responses).

For example, the peer may cache, in the search response cache 526 (FIG. 5), the search response message body 704 (FIG. 7) and the value of the responding peer ID field 712 of the peer-to-peer search response message 700, indexed by the search request message body 604 (FIG. 6) of the request message 600 that prompted the response message 700. When a subsequent peer-to-peer search request message 600 is forwarded by the response caching peer, the peer may check its search response cache 526 for a match with the search request message body 604 of the subsequent message 600 (i.e., a cache hit). If a match occurs, the peer may generate a peer-to-peer search response message 700 containing, for example, the associated search response message body 704 from the search response cache 526. As an alternative to caching some or all of the search request message body 604, the peer may cache a cryptographic hash of some or all of the search request message body 604 (a search request hash). The peer may hash some relevant portion of the search request message body 604 instead of the whole.

The response caching peer need not cache the search response message body 704 (FIG. 7). The response caching peer may, in response to the cache hit, send a peer-to-peer search response message 700 in which the search response message body 704 does not contain application-specific search response fields but in which the message 700 does include an indication of the peer that generated the response that was cached, e.g., the value of the responding peer ID field 712, as well as an indication that the response message 700 is a cached response, e.g., a cached response flag in the search response flags field 710 may be set. In this case, the originating peer, in receiving the cached response, does not receive single node search results but it does receive reference to a peer that has generated a non-cached response to the same peer-to-peer search in the past. The originating peer may then send a copy of the peer-to-peer search request message 600 to that peer, for example, by establishing a direct peer-to-peer network connection with that peer, or by conventional peer-to-peer network message routing. The cached response may include references to more than one such peer.

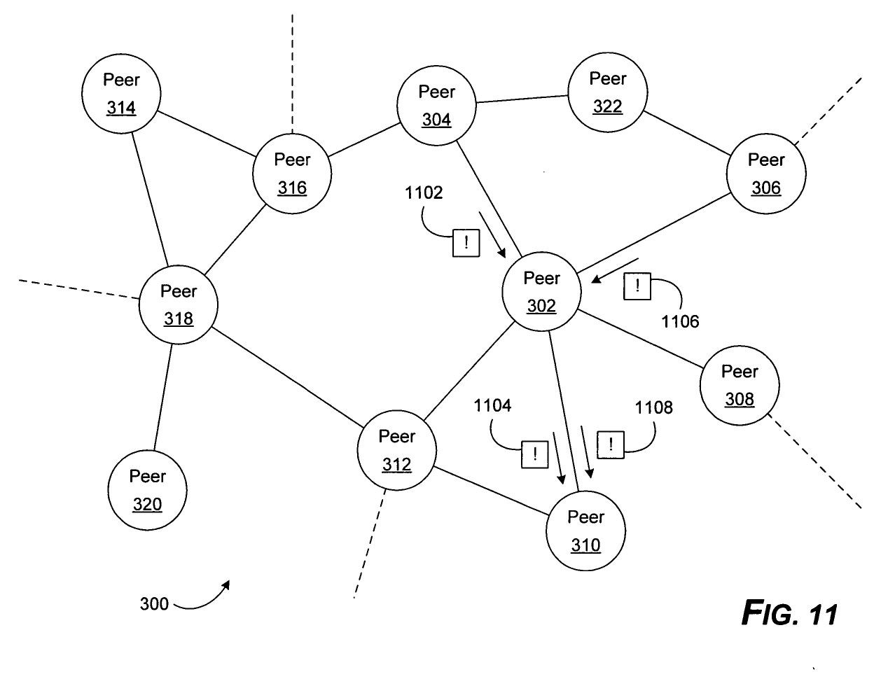

FIG. 11 depicts aspects of an example peer-to-peer search that extends the example depicted by FIG. 9. This example includes specific peer-to-peer search responses from peer 304 and peer 306 and incorporates response caching. As a result of the peer-to-peer search request messages 902, 904, 906, 908, 910, 912, 914, 916, 918, 920, 922, 924, 926, 928 (FIG. 9) propagated through the peer-to-peer network 300 from originating peer 310, successful single node searches are triggered at peer 304 and peer 306. When peer 302 forwarded request message 902 to peers 304 and 306, in addition to other information such as the search request ID of the message 902, peer 302 recorded the search request hash for the request message 902 in its search request cache 524 (FIG. 5).

As a result of the successful single node search at peer 304, peer 304 generates and sends the peer-to-peer search response message 1102 containing peer 304 single node search results to peer 302. When peer 302 receives response message 1102, peer 302 checks its search request cache 524 for the value if the search request ID field 708 of the response message 1102. If peer 302 finds the search request ID of the response message 1102 in its search request cache 524 (as it does in this example) then peer 302 records information about the response message 1102 in its search response cache 526, for example, the peer ID of the responding peer 304 indexed by the search request hash of the associated request message 902. Peer 302 then forwards the response message 1102 to peer 310 as response message copy 1104.

Peer 306 likewise generates peer-to-peer search response message 1106. Peer 302 receives response message 1106. Peer 302 finds the search request ID of response message 1106 in its search request cache 524 (FIG. 5). Peer 302 records the peer ID of responding peer 306 in its search response cache 526, associated with the search request hash of the request message 902 (FIG. 9) with the matching search request ID. Peer 302 forwards the response message 1106 to peer 310 as peer-to-peer search response message copy 1108.

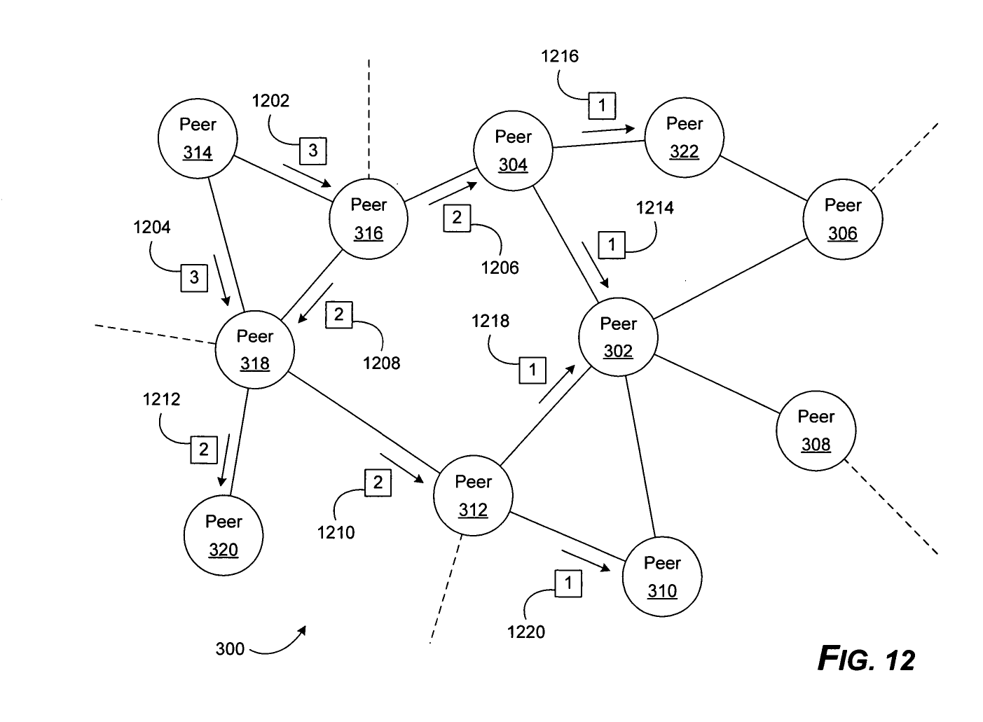

FIG. 12 depicts a second example peer-to-peer search that takes place after the events of the example peer-to-peer search described with reference to FIG. 11. The second example peer-to-peer search originates at peer 314 and has a peer-to-peer network search radius of 3. Peer 314 sends peer-to-peer search request messages 1202 and 1204 to neighboring peers 316 and 318 respectively. Request messages 1202 and 1204 have different search request IDs than the request messages 902, 904, 906, 908, 910, 912, 914, 916, 918, 920, 922, 924, 926 and 928 (FIG. 9) of the previous example but the application-specific search fields of the search request message body 604 of each request message 902, 904, 906, 908, 910, 912, 914, 916, 918, 920, 922, 924, 926, 928, 1202 and 1204 are the same, that is, peer 314 is searching the peer-to-peer network 300 for the same peer resource(s) for which peer 310 was searching in the previous example.

In an embodiment of the invention, the search request flags field 614 (FIG. 6) of the peer-to-peer search request message includes a “solicit non-cached responses” flag and a “solicit cached responses” flag. A set solicit non-cached responses flag may indicate that peers where the request message 600 triggers successful single node searches should respond with peer-to-peer search response messages. The solicit non-cached responses flag may be set by default. A set solicit cached responses flag may indicate that peers with matching associated search request hashes in their search response cache 526 (FIG. 5) should also respond with peer-to-peer search response messages. In this (FIG. 12) example each request message has both flags set.

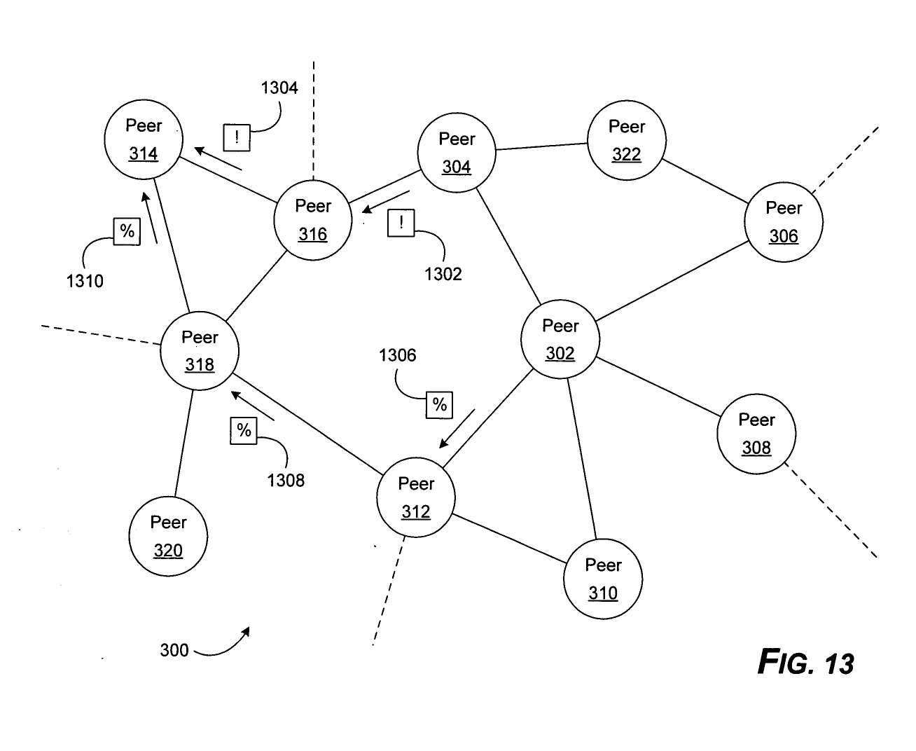

Request message 1202 is forwarded by peer 316 to peers 304 and 318 as request message copies 1206 and 1208 respectively. Request message 1204 is forwarded by peer 318 to peers 312 and 320 as request message copies 1210 and 1212 respectively. As for the previous example peer-to-peer search, successful single node searches may be triggered at peers 304 and 306. Of course, peer resource availability may change between searches but in this example it doesn't. As a result of request message 1206, peer 304 sends successful single node search results back to peer 314 via peer-to-peer search response messages 1302 and 1304 (FIG. 13). Peer 316 caches aspects of response message 1302 in its search response cache 526 (FIG. 5).

Request message 1206 is forwarded by peer 304 to peers 302 and 322 as request message copies 1214 and 1216 respectively. Request message 1210 is forwarded by peer 312 to peers 302 and 310 as request message copies 1218 and 1220 respectively. Request message 1218 arrives at peer 302 before request message 1214. As a result, request message 1214 is discarded. Although the single node search triggered at peer 302 by request message 1218 is unsuccessful, peer 302 does find two matches for the search request hash of request message 1218 in its search response cache 526 (FIG. 5). As a result, peer 302 sends a cached response containing the peer IDs of peers 304 and 306 back to peer 314 via peer-to-peer search response messages 1306, 1308 and 1310 (FIG. 13). Peer 312 caches aspects of response message 1306 in its search response cache 526. Peer 318 caches aspects of response message 1308 in its search response cache 526.

Peer 314 has already received a non-cached response from peer 304. As a result, in this example, peer 314 does not send peer 304 another peer-to-peer search request message 600 (FIG. 6). Peer 314 does send a request message 600 to peer 306 and peer 306 responds with a non-cached response (not shown in FIG. 13). In this example, peer 306 was outside the search radius of the peer-to-peer search originated by peer 314, that is, peer 306 did not receive one of the peer-to-peer search request messages 1202, 1204, 1206, 1208, 1210, 1212, 1214, 1216, 1218, 1220 (FIG. 12), and yet peer 314 was able to locate desired peer resources at peer 306. This illustrates a way that response caching in accordance with an embodiment of the invention may enhance the effective search radius of a peer-to-peer search. The mechanics of response caching may be hidden from applications 404 (FIG. 4) by the peer-to-peer search component 408, that is, application implementation need not take them into account.

In the examples described above, when sending or forwarding (i.e., multicasting) the peer-to-peer search request message 600 (FIG. 6), the peer has sent or forwarded the request message 600 to each (i.e., 100%) of its neighboring peers or none (i.e., 0%) of its neighboring peers. This procedure may ensure that each peer within a given search radius receives the request message 600. However, it is not necessary in a peer-to-peer search in accordance with an embodiment of the invention for each peer within a given search radius to receive the request message 600, although good coverage (e.g., more than 50% of peers within a given search radius) is desirable. In some peer-to-peer networks, peers are so well connected, i.e., have a high number (e.g., more than 3) of neighbors on average, that multicasting the request message 600 to each neighbor results in an excessive number of duplicate request messages 600 arriving at peers and thus inefficiency. In well connected peer-to-peer networks (i.e., peer-to-peer networks with well connected peers) good coverage and increased efficiency may be achieved by multicasting the request message 600 to less than 100% of the peer's neighbors (“probabilistic multicast”).

In an embodiment of the invention, the peer selects a set of its neighbors to which to multicast the peer-to-peer search request message 600 (a “multicast set”), each neighbor having a peer-to-peer search multicast probability of being included in the multicast set. For example, the multicasting peer may generate a random or pseudo-random number (e.g., a value between 0% and 100%) for each neighbor and send the request message 600 to the neighbor if the pseudo-random number generated for the neighbor is less than the peer-to-peer search multicast probability (e.g., a value between 50% and 100%). For example, with reference to FIG. 14, peer 302 is multicasting the peer-to-peer search request message 600 with a peer-to-peer search multicast probability of 60% as part of a peer-to-peer search with a search radius of 3. Peer 302 considers each of its neighbors in turn. For peer 304, peer 302 generates a pseudo-random number less than the multicast probability. As a result, peer 302 sends the request message 600 to peer 304 as request message copy 1402. For peer 306, peer 302 generates a pseudo-random number greater than the multicast probability. As a result, peer 302 does not send the request message 600 to peer 306. Similarly, peer 302 does send the request message 600 to peers 308 and 312 as request message copies 1404 and 1406 respectively but does not send the request message 600 to peer 310.

Peer 304 multicasts request message 1402 to its neighbors with a multicast probability of 100%. As a result, when peer 304 generates a pseudo-random number for each of its neighbors, the pseudo-random number is less than the multicast probability. Peer 304 multicasts request message 1402 to peers 316 and 322 as request message copies 1408 and 1410. Similarly, peer 312 multicasts request message 1406 with a multicast probability of 100% to peers 310 and 318 as request message copies 1412 and 1414. Peer 316 multicasts request message 1408 with a probability of 100% to peers 314 and 318 as request message copies 1416 and 1418 respectively. Peer 318 multicasts request message 1414 with a peer-to-peer search multicast probability of 60%. The pseudo-random numbers generated for neighboring peers 314 and 316 are greater than 60%, the number generated for peer 320 is less. Peer 318 sends request message copy 1420 to peer 320. Peer 322 multicasts request message 1410 with a probability of 100% to peer 306 as request message copy 1422.

In this example, the peer-to-peer search initiated by peer 302 has achieved 100% coverage of the peers depicted in FIG. 14 and with a low number of duplicate peer-to-peer search request messages arriving at the peers. However, 100% coverage is not guaranteed by probabilistic multicast. If maximized coverage is more desirable than, for example, efficiency, the probabilistic multicast feature may be disabled by setting or resetting a peer-to-peer search request message 600 (FIG. 6) flag. For example, the search request flags field 614 may include an enable probabilistic multicast flag.

The multicast probability value utilized by the multicasting peer may be a constant (e.g., 50%). The multicast probability value utilized by the multicasting peer may depend upon the number of neighbors of the multicasting peer, the value of the search radius field 610 (FIG. 6) of the request message 600 being multicast, the number of peer-to-peer network hops of the multicasting peer from the originating peer (which may be the same as the value of the search radius field 610), localized peer-to-peer network topographical statistics such as the average number of neighbors of the multicasting peer and its neighbors, or a combination of such factors. For example, if the multicasting peer has less than 4 neighbors, the peer may utilize a multicast probability of 100% and if the multicasting peer has 4 or more neighbors, the peer may utilize a progressively lower multicast probability (e.g., 90% for 4 neighbors, 80% for 5 neighbors, 70% for 6 neighbors, and so on) until a minimum multicast probability (e.g., 50%) is reached. Alternatively, the request message 600 may be multicast with 100% probability for its first multicast from the originating peer and then with progressively lower multicast probabilities for subsequent multicasts, e.g., 90% for the second multicast, 80% for the third multicast, 70% for the fourth multicast and so on, until a minimum (e.g., 50%) is reached. Multicast probability may be utilized as an alternative to (or in addition to) search radius, with multicast probability beginning high (e.g., 100%) and then reducing, not necessarily in a linear manner, to 0% with each multicast.

Multicasting the request message 600 to less than 100% of the peer's neighbors may result in some peers not receiving a copy of the request message 600 and thus suboptimal peer-to-peer search coverage. In an embodiment of the invention that incorporates duplicate filtering mechanisms, better coverage with similar efficiency may be achieved by delaying multicast of the request message 600 to some peers rather than omitting multicast to those peers. For example, a multicast with 75% probability from a peer may omit 25% of the peer's neighbors. Rather than omitting those 25%, multicast of the request message 600 to those neighbors is merely delayed for, e.g., half a second. Those neighbors receiving the delayed multicast that already received the request message 600 during the earlier (non-delayed) multicast may discard the request messages of the delayed multicast as duplicates. However, any neighbors that did not receive the request message 600 as part of the earlier multicast are added to the coverage of the associated peer-to-peer search by the delayed multicast.

In an embodiment of the invention, each peer-to-peer search is associated with an application-specific search type. The value of the search type field 618 (FIG. 6) of each peer-to-peer search request message 600 may indicate the application-specific search type of the peer-to-peer search associated with the request message 600. Example search type field 618 values include integers and alphanumeric strings.

As an alternative to utilizing a single peer-to-peer search multicast probability, the multicasting peer may determine a multicast probability value for each neighbor. For example, a first neighbor of the multicasting peer may have an associated multicast probability value of 75% and a second neighbor of the multicasting peer may have an associated multicast probability value of 25%. The multicast probability value for each neighbor of the multicasting peer may be dependent on the search type associated with the peer-to-peer search request message 600 being multicast. For example, a particular neighbor of the multicasting peer may have an associated multicast probability value of 80% for a request message 600 associated with a first search type and 20% for a request message 600 associated with a second search type.

In an embodiment of the invention, the multicast probability value associated for a particular neighbor and a particular search type is related (e.g., proportional) to how frequently the neighbor has responded to the search type in the past. For example, if the multicasting peer has 2 neighbors and the first neighbor has routed a response message 700 (FIG. 7) to the multicasting peer in response to a particular search type 4 times out of the last 5, and the second neighbor has routed a response message 700 to the multicasting peer in response to the particular search type once out of the last 5 times, then the multicast probability associated with the first neighbor for that search type may be 80% and the multicast probability associated with the second neighbor for that search type may be 20%. The relation need not be strictly proportional, any suitable scheme that allocates a higher probability to neighbors responding more frequently to a particular search type may be incorporated into an embodiment of the invention. Search response cache 526 (FIG. 5) statistics may be utilized to determine neighbor response frequency by search type.

Despite efficiency measures, each peer-to-peer search may consume significant collective peer-to-peer network resources such as bandwidth and processing power. In order to reduce the likelihood that a malicious (or impolite) peer is able to consume a significant fraction of collective peer-to-peer network resources the peer-to-peer search component 408 (FIG. 4) may incorporate peer-to-peer search throttling mechanisms. Each peer that receives peer-to-peer search request messages may, in addition to any other information, record in its search request cache 524 (FIG. 5) the neighbor (e.g., the peer ID of the neighbor) that sent the request message 600 (FIG. 6) to the peer and the time that the request message 600 was received. In this way, the peer receiving peer-to-peer search request messages from its neighbors may determine the rate (e.g., the number of request messages per minute) at which each neighbor is sending peer-to-peer search request messages to the receiving peer. Alternatively, or in addition, the peer may maintain request message 600 receive rate counters for each neighbor. Other suitable rate measuring mechanisms are possible as will be apparent to one of skill in the art.

In an embodiment of the invention, if the peer receives peer-to-peer search request messages from a particular neighbor at a rate above a configured maximum peer-to-peer search request rate (e.g., 10 or 15 requests per minute) then those request messages that are received in excess of the maximum peer-to-peer search request rate are discarded. This rate-based search request throttling may limit the collective peer-to-peer network resource damage that the malicious peer is able to do through a single search request receiving peer. However, the malicious peer is still able to consume some collective peer-to-peer network resources. For the computational investment of sending a single peer-to-peer search request message, the malicious peer may be able to affect a large number of peers in the peer-to-peer network. In addition, it is common in peer-to-peer networks to be able to become neighbors of a plurality of peers in the peer-to-peer network and to be able to change those neighbors over time. As a result, rate-based search request throttling alone may be ineffective in limiting the collective peer-to-peer network resource abuse of the malicious peer.

In an embodiment of the invention, the peer receiving the peer-to-peer search request message 600 (FIG. 6) discards the request message 600 unless the request message 600 includes a valid solution to a puzzle that is computationally expensive to solve. An originating peer that fails to invest the computation resources to solve the puzzle risks having the peer-to-peer search request messages that it sends discarded. Each originating peer has finite computational resources. As a result, originating peers that do invest the computational resources to solve the puzzle are, to some extent, self limiting. It is desirable that the computational puzzle be difficult (computationally expensive) to solve and easy (computationally inexpensive) to verify. In an embodiment of the invention, the puzzle is solved once at the originating peer and verified at each forwarding peer. It may be further desirable that the computational puzzle is capable of being configured so as to be more or less difficult, for example, so that the puzzle may be made more difficult with increasing search radius. In the example peer-to-peer search request message depicted in FIG. 6, the puzzle solution is stored in the distributed throttling token field 612.

The following equation represents an example of a suitable computational puzzle.
H(msg+P)modN=TmodN

In the above equation, H( ) represents a cryptographic one way function such as the well known SHA1 secure hash algorithm. The msg parameter represents the peer-to-peer search request message 600 (FIG. 6) with any fields that change from copy to copy such as the search radius field 610 and the peer-to-peer routing path field 620 stripped out or set to a known constant (e.g., 0). The distributed throttling token field 612 may also be stripped out or set to a known constant when solving the puzzle. The P parameter represents the puzzle solution. This is the value that may be stored in the distributed throttling token field 612. The ‘+’ operator between the msg and P parameters may represent string concatenation. Ignoring the mod N operation, T is the known target value for which the originating peer tries to find puzzle solution P, so that when puzzle solution P is concatenated with the msg parameter and transformed by the one way function H the result is the known target value T. T may be any suitably unpredictable value that changes periodically and is known by each peer in the peer-to-peer network. For example, T may be the current graph time of the peer-to-peer network or a pseudo-random number periodically flooded to each peer in the peer-to-peer network. The parameter N enables the computational difficultly of the puzzle to be varied.

As a result of the nature of the one way function H( ), there is not a computationally easier way to solve the puzzle than trying different (e.g., successive) values of P, evaluating the left hand side of the equation and comparing it to the right hand side. The mod N term on both sides of the equation ensures that a suitable P may be found in at most N tries and in half that many tries on average. The value of N may be chosen so as to pose a significant computational challenge to a modern computer system, for example, 1 second of processing unit 202 (FIG. 2) time at 100% utilization, and, in an embodiment of the invention, is typically restricted to prime or near-prime values. The value of N may be varied as a, for example, linear or exponential, function of search radius so that originating a peer-to-peer search of large search radius requires additional computational expenditure.

Having determined the puzzle solution P, the originating peer may set the value of the distributed throttling token field 612 of the peer-to-peer search request message 600 (FIG. 6) to that value and sends the request message 600 to its neighbors as described above. Each peer that receives the request message 600 may verify that the puzzle has been solved with a single equation evaluation. If the verification fails, the request message 600 may be discarded. As a result, the number of request message 600 copies propagated by a malicious peer may be reduced.

The peer-to-peer search described above may be utilized by the originating peer to retrieve information located at peers within the search radius of the peer-to-peer search. Such peer-to-peer searches may be utilized for resource discovery, for example, the information retrieved by the peer-to-peer search may be the simple yes or no answer to the question “do you have resource X?” from each peer within the search radius of the peer-to-peer search. In an embodiment of the invention, peer-to-peer searches are also utilized for resource reservation. When applications 404 (FIG. 4) utilize the peer-to-peer search component 408 for resource reservation, a peer responding as a result of a successful single node search may reserve or lock the target of the peer-to-peer search for some period of time and record that time in the resource reservation time field 716 (FIG. 7) of the peer-to-peer search response message 700. A reservation expiration timestamp may be recorded in the resource reservation time field 716. The reservation time may be estimated rather than guaranteed. Peer-to-peer search responses that say “resource X is reserved until time T” or “resource X is available until time T” rather than “resource X was available at the time of this response” may form the basis of a robust peer-to-peer reservation system.

Peer-to-peer searches in accordance with an embodiment of the invention may also be utilized to retrieve information about the peer-to-peer network itself. Each peer in the peer-to-peer network may have a peer-to-peer ping application registered with the peer-to-peer search component 408 (FIG. 4) of the peer. The peer-to-peer ping application may respond to peer-to-peer search request messages, for example, with search type “ping.” The originating peer of the ping-type peer-to-peer search may receive peer-to-peer search response messages from each peer in the search radius and, as a result, learn, for example, the peer ID of each peer in the search radius as well as the round-trip time to each peer in the search radius. If each ping-type peer-to-peer search response message includes the peer-to-peer request routing path field 714 (FIG. 7), the originating peer may be able to determine the current peer-to-peer network topology within the search radius, that is, the peer-to-peer ping mechanism may support a peer-to-peer traceroute analogous to the well known data transport network traceroute diagnostic application.

Each peer-to-peer search request message may include search credentials provided by the originating peer. For example, the search credentials may be recorded in the search credentials field 616 (FIG. 6) of the peer-to-peer search request message 600. The search credentials may provide authentication information to the peer, for example, username and password or an electronic signature, that authorizes the originating peer to access resources at the peer receiving the peer-to-peer search request message. Authentication may be required at the receiving peer, for example, to implement a security policy or to authorize payment for resource access.

There follows example steps that may be performed by the computer 102 (FIG. 2) to implement peer-to-peer search features in accordance with an embodiment of the invention. For example, the example steps may be performed by the peer-to-peer search component 408 (FIG. 5).

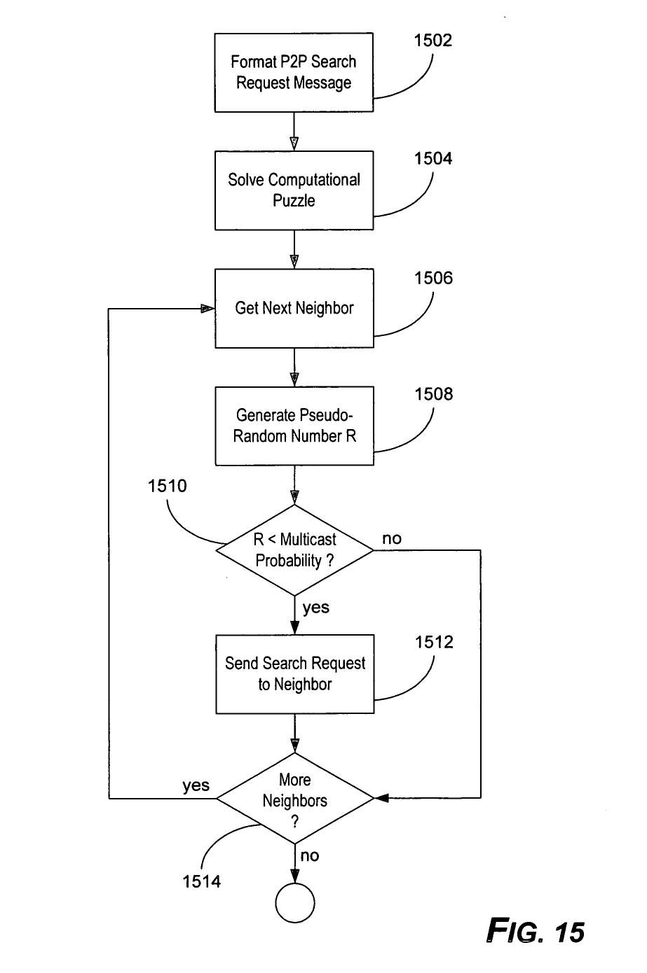

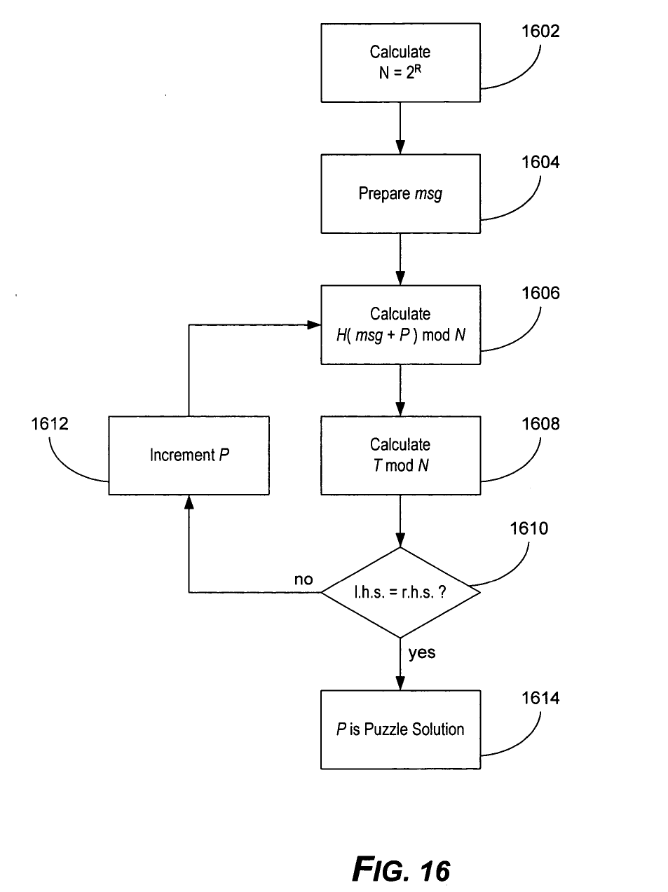

FIG. 15 depicts example steps that may be performed to send the peer-to-peer search request message from the originating peer in accordance with an embodiment of the invention. For example, the steps depicted in FIG. 15 may be performed by the send search request module 508 (FIG. 5) to send the peer-to-peer search request message 600 (FIG. 6). At step 1502, the peer-to-peer search request message 600 is formatted into a suitable communication message format, for example, a binary message format in accordance with FIG. 6. Following step 1502, the value of the distributed throttling token field 612 of the request message 600 may not be a suitable computational puzzle solution. At step 1504, various values are tried until one of the values is a suitable computational puzzle solution. Example steps for finding a suitable computational puzzle solution are described in more detail with reference to FIG. 16.

Following step 1504, the request message 600 is ready for sending to the neighboring peers of the originating peer. At step 1506, the originating peer determines the next candidate neighbor. At step 1508, the peer generates a pseudo-random number R. At step 1510, that number R is compared to the peer-to-peer search multicast probability for that neighbor. If the number R is less than the multicast probability, the procedure progresses to step 1512. Otherwise, the procedure progresses to step 1514. At step 1512, the formatted peer-to-peer search request message is sent to the candidate neighbor. At step 1514, the peer determines if there are more candidate neighbors to consider. If there are, the procedure returns to step 1506. Otherwise, the peer-to-peer search request message has been sent from the originating peer.

This example incorporates probabilistic multicast. If probabilistic multicast is disabled, steps 1508 and 1510 may be skipped, that is, the procedure may progress directly from step 1506 to step 1512. Probabilistic multicast may be disabled on a per peer basis or a per message basis. For example, the search request flags field 614 may include an enable probabilistic multicast flag that disables probabilistic multicast for the particular request message if the flag is not set.

FIG. 16 depicts example steps that may be performed to solve the distributed throttling computational puzzle for a particular peer-to-peer search request message in accordance with an embodiment of the invention. For example, the steps depicted in FIG. 16 may be performed by the send search request module 508 (FIG. 5) to solve the computation puzzle for the peer-to-peer search request message 600 (FIG. 6). At step 1602, the puzzle difficulty parameter N is calculated as 2 raised to the power of the request message 600 search radius R, that is, 2 raised to the power of the value of the search radius field 610 of the request message 600. Some of the fields of the peer-to-peer search request message 600 may change as the request message 600 is forwarded through the peer-to-peer network, for example, the search radius field 610. At step 1604, a copy msg of the request message 600 is prepared for processing by stripping out those fields.

At step 1606, the left hand side (l.h.s.) of the computational puzzle is evaluated as previously described with the default value of the puzzle solution P (e.g., 0). At step 1608, the right hand side (r.h.s.) of the computational puzzle is evaluated as previously described with the current value of the periodically varying target T. At step 1610, the left hand side of the puzzle is compared to the right hand side. If the two sides are not the same, the procedure progresses to step 1612. At step 1612, the puzzle solution P is incremented and the procedure returns to step 1606 to try the new value. If the two sides are the same, the puzzle solution has been found. The procedure progresses to step 1614. The nature of the one way function H( ) is such that the two sides will be the same for at least one value of the puzzle solution P. At step 1614, the puzzle solution P may be recorded in the distributed throttling token field 612 (FIG. 6) of the request message 600.

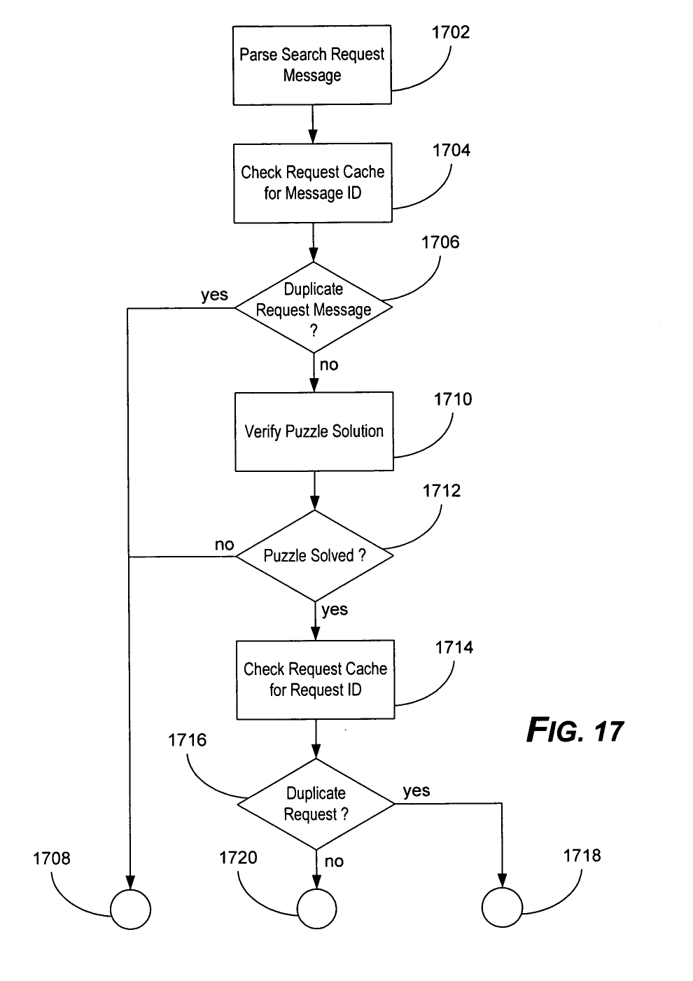

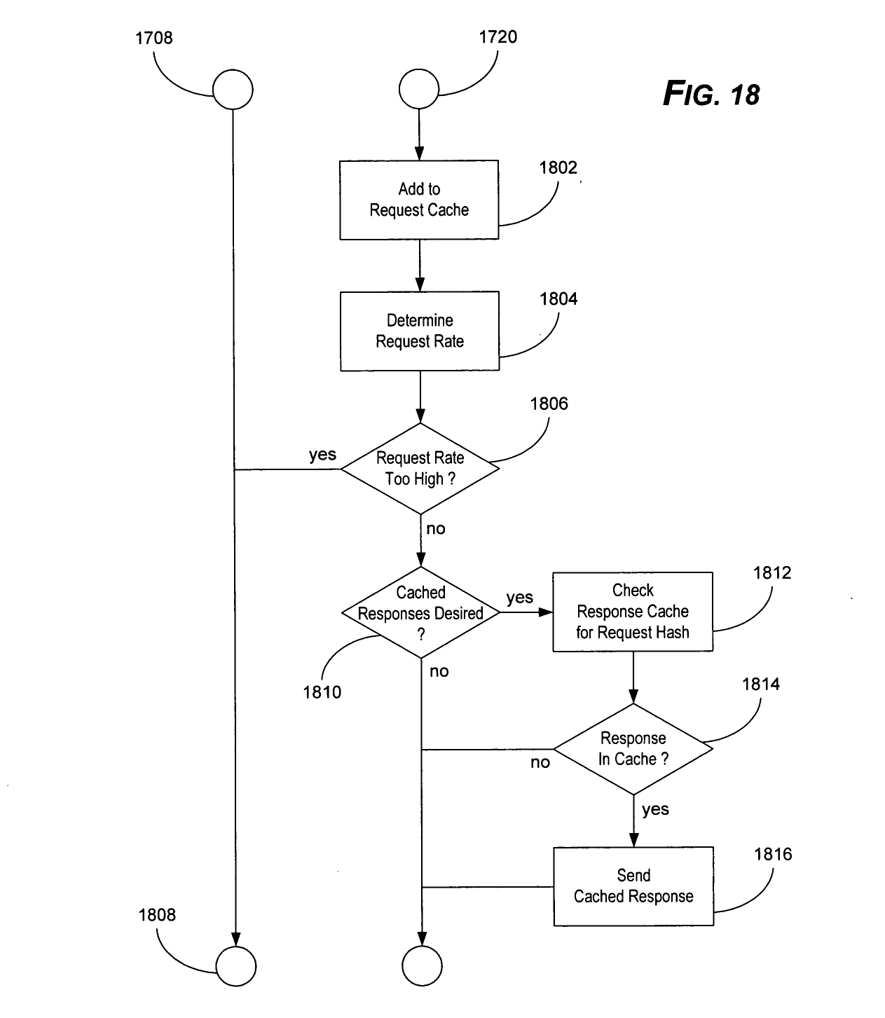

FIG. 17 and FIG. 18 depict example steps that may be performed to filter incoming peer-to-peer search request messages in accordance with an embodiment of the invention. For example, the steps depicted in FIG. 17 and FIG. 18 may be performed by the receive search request module 512 (FIG. 5) and/or the search message filter module 516 to process the peer-to-peer search request message 600 (FIG. 6). At step 1702, the incoming request message 600 is parsed, for example, by the receive search request module 512 and the resulting data structure is passed to the search message filter module 516.

At step 1704, the search message filter module 516 checks the search request cache 524 for the search request message ID of the request message 600 (i.e., the value of the search request message ID field 606). At step 1706, if the search request message ID was found in the search request cache 524, then the incoming request message 600 is determined to be a duplicate request message 600. If the incoming request message 600 is determined to be a duplicate then the request message 600 is discarded 1708. Procedural link 1708 leads to a request message 600 discarded outcome for this example procedure. Otherwise, the procedure progresses to step 1710.

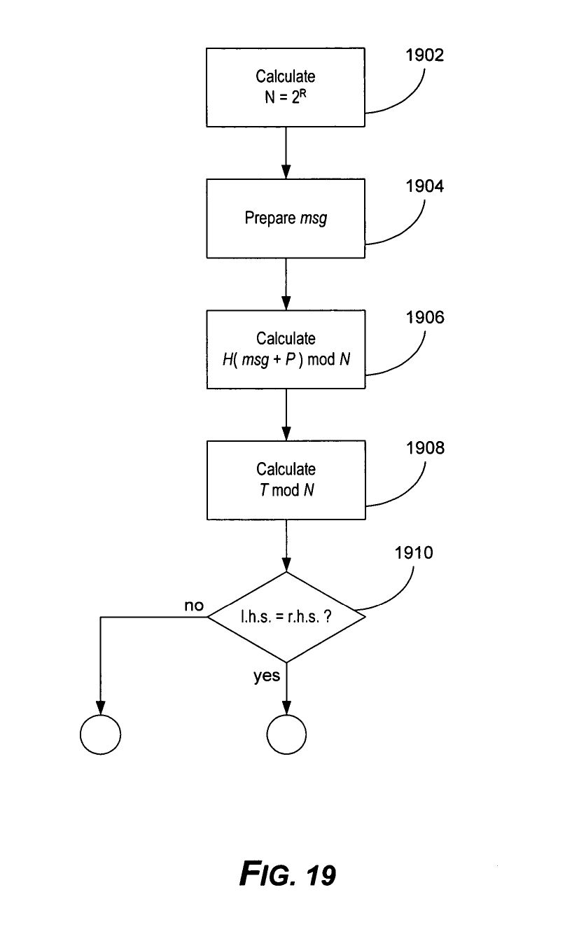

At step 1710, it is verified that the distributed throttling computational puzzle for the request message 600 was solved by the originating peer. At step 1712, the request message 600 is discarded 1708 if the puzzle solution verification fails. Otherwise, the procedure progresses to step 1714. Steps 1710 and 1712 are described below in more detail with reference to FIG. 19.

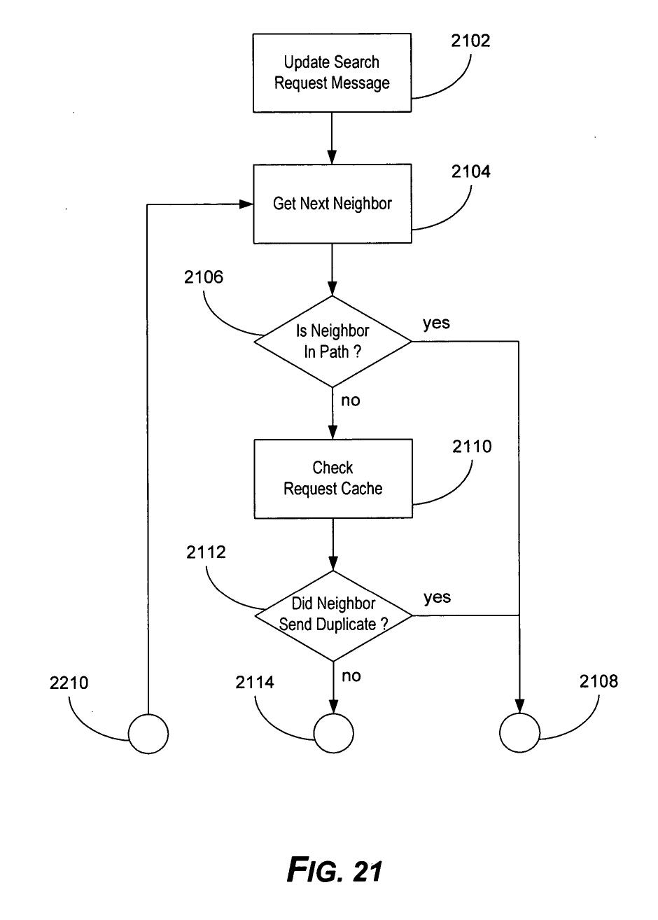

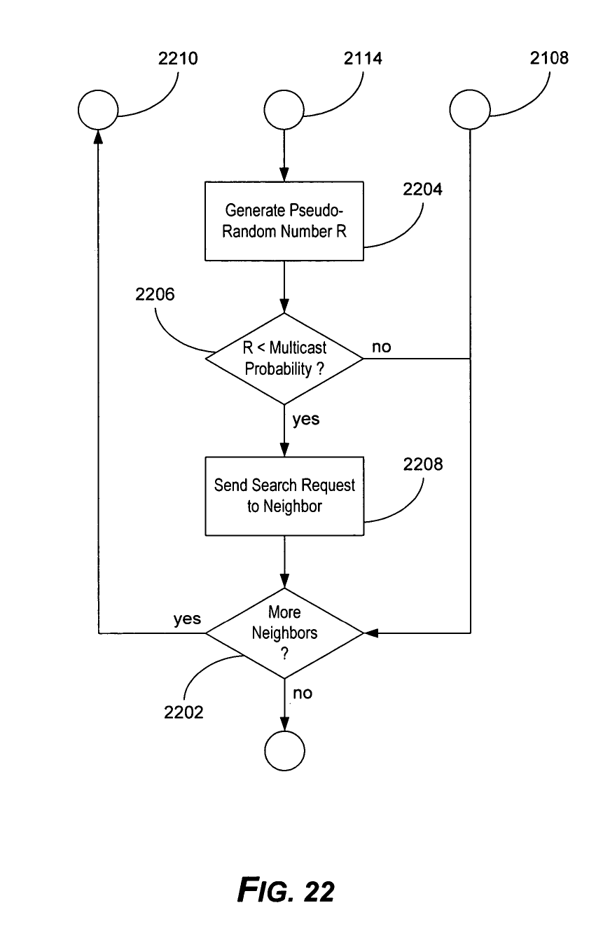

At step 1714, the search message filter module 516 checks the search request cache 524 for the search request ID (i.e., the value of the search request ID field 608) of the request message 600. At step 1716, if the search request ID was found in the search request cache 524, then the incoming request message 600 is determined to be part of a duplicate peer-to-peer search. If the incoming request message 600 is determined to be part of a duplicate peer-to-peer search then the request message 600 is forwarded (via procedural link 1718 to a forwarding procedure, for example, the forwarding procedure described below with reference to FIG. 21 and FIG. 22) but is not further considered as a candidate for response by the peer performing the procedure. Otherwise, the request message 600 is so further considered in FIG. 18 via link 1720.

At step 1802, information regarding the peer-to-peer search request is added to the search request cache 524. For example, the value of the search request message ID field 606 (FIG. 6), the value of the search request ID field 608, the value of the search type field 618, the contents of the peer-to-peer routing path field 620, the search request hash of the request message 600, and a time received timestamp for the request message 600 may be added to the search request cache 524. The search request cache 524 may collate the added data in multiple ways. The data may be contained in a single cache object/table or be distributed across multiple cache objects/tables. Portions of the search request cache 524 may be optimized for performance reasons, for example, the search request cache 524 may maintain a circular buffer of the last, for example, one hundred search request message IDs added to the cache 524.

At step 1804, the search request rate for the peer that sent the request message 600 is determined. The search request rate for the peer may be calculated from search request cache 524 statistics as the number of peer-to-peer search request messages received from the peer in a given time period (e.g., the last one minute). Alternatively, the search request cache 524 may maintain search request rate counters for each neighbor that are incremented when a request message 600 arrives from the neighbor and are decremented periodically. If such counters are maintained, the search request rate for the peer is determined by reading the current value of the corresponding counter. At step 1806, the determined search request rate is compared to a configured maximum. If the search request rate exceeds the maximum, the request message 600 is discarded 1808. As for procedural link 1708, procedural link 1808 leads to the request message 600 discarded outcome for this example procedure. Otherwise, the procedure progresses to step 1810.

At step 1810, the processing peer determines if the originating peer desired cached responses in addition to, or instead of, non-cached responses. For example, if the solicit cached responses flag of the search request flags field 614 of the request message 600 is set then cached responses are desired and the procedure progresses to step 1812. Otherwise, cached responses are not desired and the request message 600 may be passed to other modules for additional processing such as the application peer-to-peer search registry module 522 and the forward search request module 518.

At step 1812, the search response cache 526 is checked for the search request hash of the request message 600. If the search response cache 526 contains the search request hash of the request message 600, then, at step 1814, it is determined that a cached response to the request message 600 may be generated from the information in the search response cache 526 and the procedure progresses to step 1816. Otherwise, a cached response is not available and the request message 600 may be passed to other modules for additional processing. At step 1816, a cached response is generated and dispatched to the originating peer as previously described.

FIG. 19 depicts example steps that may be performed to verify that the distributed throttling computational puzzle was solved by the originating peer of a particular peer-to-peer search request message in accordance with an embodiment of the invention. For example, the steps depicted in FIG. 19 may be performed by the search message filter module 516 (FIG. 5) to verify the value of the distributed throttling token field 612 (FIG. 6) of the peer-to-peer search request message 600. The procedure to verify the distributed throttling computational puzzle has similarities to the procedure to solve the computation puzzle described above with reference to FIG. 16.

At step 1902, the puzzle difficulty parameter N is calculated as 2 raised to the power of the request message 600 search radius R. This search radius R is the initial value of the search radius field 610 of the request message 600, not necessarily the value of the search radius field 610 when the request message 600 is received by the peer performing this verification procedure. The initial search radius may be stored in a peer-to-peer search request message field not shown in FIG. 6, or the current value of the search radius field 600 may be adjusted by the number of peers that have been added to the peer-to-peer routing path field 620. Other equivalent schemes for acquiring the value of the initial search radius are possible as will be apparent to one of skill in the art.

At step 1904, a copy msg of the received request message 600 is prepared for the verification process by stripping out those fields that have changed as the request message 600 was propagated through the peer-to-peer network as well as the distributed throttling token field 612. Following step 1904, the copy msg corresponds to the data object that was generated by step 1604 (FIG. 16) and utilized in solving the computational puzzle. At step 1906, the left hand side (l.h.s.) of the computational puzzle is evaluated as previously described with the value of the puzzle solution P set to the value of the distributed throttling token field 612. At step 1908, the right hand side (r.h.s.) of the computational puzzle is evaluated as previously described with the corresponding value of the periodically varying target T. In this example the target T is the graph time when the request message 600 was generated, however, the target T may be a value that is periodically flooded to each peer of the peer-to-peer graph. Additional suitable target value distribution schemes will be apparent to one of skill in the art.

At step 1910, the right hand side of the computational puzzle as calculated at step 1906 is compared to the left hand side of the computational puzzle as calculated at step 1908. If the two sides are the same, the puzzle solution is verified and the procedure progresses on that basis, for example, to step 1714 of FIG. 17. If the two sides are not the same, then the verification fails and the request message 600 will be discarded.

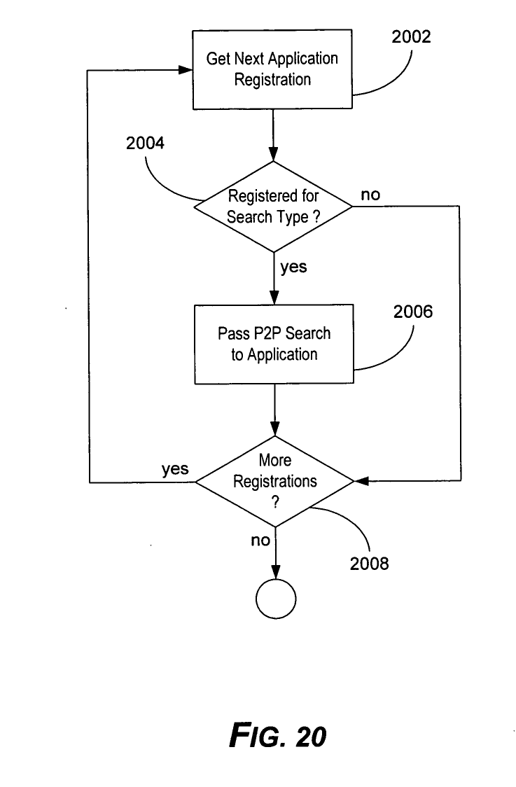

FIG. 20 depicts example steps that may be performed to pass incoming peer-to-peer search requests to registered applications in accordance with an embodiment of the invention. For example, the steps depicted in FIG. 20 may be performed by the application peer-to-peer search registry module 522 (FIG. 5) to pass application-specific search fields of the search request message body 604 (FIG. 6) of the peer-to-peer search request message 600 to registered applications 404 (FIG. 4). Interested applications 404 may register with the peer-to-peer search component 408 to receive incoming peer-to-peer search requests. Applications 404 may register for one or more particular search types or for any search type.

At step 2002, the next application registration is retrieved from a collection of application registrations. At step 2004, the application registration is examined for the search type of the request message 600, that is, for the value of the search type field 618. If the application registration includes the search type of the request message 600, the procedure progresses to step 2006. Otherwise, the procedure progresses to step 2008. At step 2006, the application-specific search fields of the search request message body 604, or, alternatively, the entire request message 600, are passed to the registered application. For example, when registering, the application may provide a callback function or the like. A separate thread of execution may be spawned to handle the application's response. At step 2008, the registration collection is checked for more registrations. If there are more registrations, the procedure returns to step 2002. Otherwise, the peer-to-peer search request has been passed to each interested application.

The application peer-to-peer search registry module 522 is not limited to discriminating between peer-to-peer searches by search type as described with reference to FIG. 20. A publish-subscribe mechanism is also possible wherein applications 404 subscribe to peer-to-peer search events which may be triggered, for example, by the receipt of the peer-to-peer search request message. The attributes of such peer-to-peer search events may include the attributes of the query contained in the application-specific search fields of the search request message body 604.

FIG. 21 and FIG. 22 depict example steps that may be performed to forward peer-to-peer search request messages in accordance with an embodiment of the invention. For example, the steps depicted in FIG. 21 and FIG. 22 may be performed by the forward search request module 518 (FIG. 5) to forward the peer-to-peer search request message 600 (FIG. 6). At step 2102, the request message 600 is updated for forwarding. For example, the peer performing the step may add itself to the peer-to-peer routing path field 620 of the request message 600 and/or decrement the search radius field 610 value as previously described.

At step 2104, the next candidate neighbor is selected, for example, from the neighbors of the peer performing the step. At step 2106, the peer-to-peer routing path field 620 of the request message 600 to be forwarded is checked for the candidate neighbor. If the neighbor is in the peer-to-peer routing path field 620 of the request message 600, it is not necessary to forward the request message 600 to that neighbor and the procedure progresses to step 2202 (FIG. 22) via link 2108 to check if there are more candidate neighbors. Otherwise, the procedure progresses to step 2110.

At step 2110, the search request cache 524 is checked for the search request message ID of the request message 600. If the search request cache 524 contains the search request message ID of the request message 600 and, in the cache 524, that search request message ID is associated with the peer ID of the candidate neighbor then, at step 2112, it is determined that the candidate neighbor recently sent a duplicate peer-to-peer search request message. As a result, it is not necessary to forward the request message 600 to the candidate neighbor and the procedure progresses to step 2202 (FIG. 22) via link 2108. Otherwise, the procedure progresses to step 2204 via link 2114.

Referring to FIG. 22, at step 2204, a pseudo-random number R is generated. At step 2206, that number R is compared to the peer-to-peer search multicast probability for the candidate neighbor. If the number R is less than the multicast probability, the procedure progresses to step 2208. Otherwise, the procedure progresses to step 2202. At step 2208, the updated request message 600 is sent to the candidate neighbor. At step 2202, it is determined if there are more candidate neighbors. If there are more candidate neighbors, the procedure returns to step 2104 (FIG. 21) via link 2210. Otherwise, the peer-to-peer search request message 600 has been forwarded. As for the example steps described with reference to FIG. 15, probabilistic multicast (i.e., steps 2204 and 2206) may be disabled on a per peer or a per message basis.

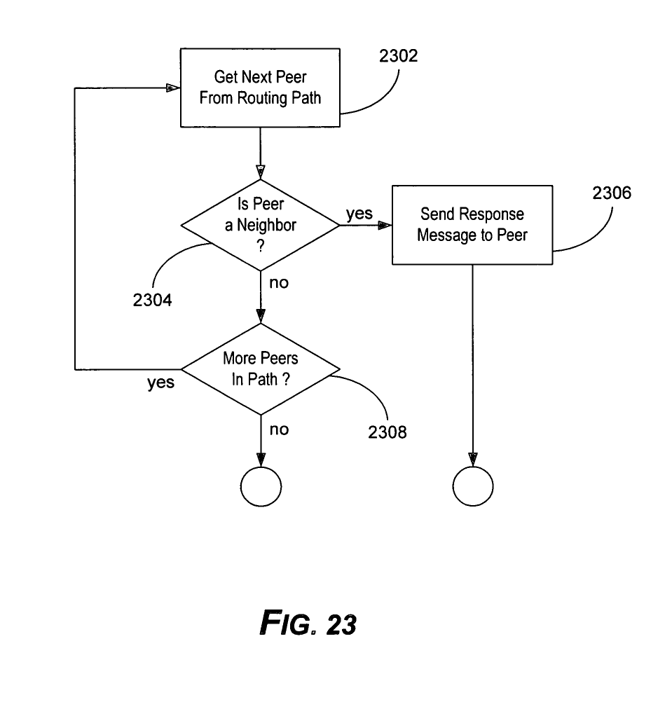

FIG. 23 depicts example steps that may be performed to route peer-to-peer search response messages in accordance with an embodiment of the invention. For example, the steps depicted in FIG. 23 may be performed by the send search response module 510 (FIG. 5) and the forward search response module 520 to route the peer-to-peer search response message 700 (FIG. 7) to the originating peer of the associated peer-to-peer search request message 600 (FIG. 6). The peer-to-peer search response message 700, formatted, for example, in a binary communications format, may be sent directly to the originating peer or may be routed back through the peer-to-peer network. The associated request message 600 may include a route direct flag in its search request flags field 614 which may be unset by default. If the route direct flag is set, associated response messages are sent directly to the originating peer if possible, including the establishment of new peer-to-peer network connections if necessary. Otherwise, the example steps depicted in FIG. 23 may be performed.

The peer-to-peer request routing path field 714 (FIG. 7) of the peer-to-peer search response message 700 may contain a copy of the peer-to-peer routing path field 620 (FIG. 6) of the associated peer-to-peer search request message 600. The peers listed in the peer-to-peer request routing path field 714 may be in order from the originating peer to the neighbor of the responding peer. At step 2302, the peer-to-peer request routing path 714 of the peer-to-peer search response message 700 is examined, in order, for the next candidate peer, beginning with the originating peer. At step 2304, it is determined if the candidate peer is a neighbor of the forwarding peer. If the candidate peer is a neighbor of the forwarding peer then the procedure progresses to step 2306. Otherwise the procedure progresses to step 2308. At step 2306, the response message 700 is sent to the candidate peer. At step 2308, the peer-to-peer request routing path field 620 of the response message 700 is checked for more candidate peers. If there are more candidate peers, the procedure returns to step 2302 to select the next candidate peer. Otherwise, none of the peers in the peer-to-peer request routing path field 714 are neighbors of the responding peer and remedial action may be taken before another attempt to respond is made.

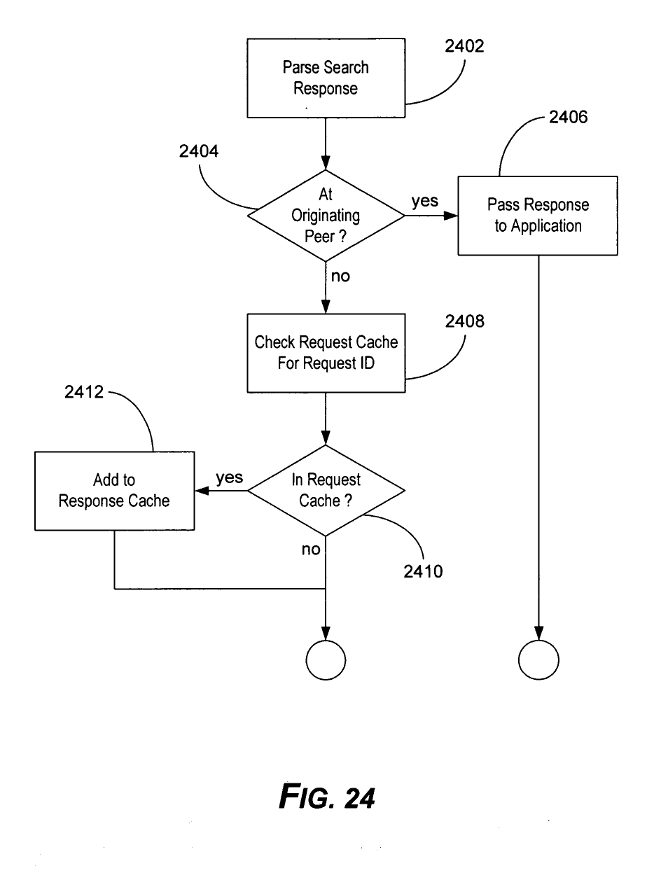

FIG. 24 depicts example steps that may be performed to process received peer-to-peer search response messages in accordance with an embodiment of the invention. For example, the steps depicted in FIG. 24 may be performed by the receive search response module 514 (FIG. 5) and the forward search response module 520 to process the peer-to-peer search response message 700 (FIG. 7). At step 2402, the received peer-to-peer search response message 700 is parsed, for example, by the receive search response module 514. At step 2404, the receiving peer determines if the received response message 700 was generated in response to a peer-to-peer search request message 600 (FIG. 6) originated by the receiving peer, that is, if the received response message 700 has arrived at the originating peer of the associated peer-to-peer search. If the received response message 700 has arrived at the originating peer of the associated peer-to-peer search, then the procedure progresses to step 2406. Otherwise, the procedure progresses to step 2408.

At step 2406, the application-specific search response fields of the search response message body 704 of the response message 700 are passed to interested applications, e.g., applications 404 (FIG. 4) registered for response messages associated with a particular search request ID. Alternatively, the entire search response message body 704 or even the entire search response message 700 may be passed to interested applications. The application peer-to-peer search registry module 522 may provide the mechanism for interacting with the applications 404 as previously described. Following step 2406, processing may be completed with respect to the response message 700. In an embodiment of the invention, registered applications located at any peer receiving the response message 700 are passed attributes of the response message 700 as specified by the registration.

At step 2408, the search request cache 524 is checked for the presence of the search request ID of the received response message 700, i.e., the value of the search request ID field 708 of the response message 700. If the search request cache 524 contains the search request ID then, at step 2410, it is determined that the receiving peer previously forwarded the peer-to-peer search request message 600 associated with the response message 700, that is, that information associated with the previously forwarded request message 600 is in the search request cache 524, and the procedure progresses to step 2412. At step 2412, information associated with the response message 700 is added to the search response cache 526.

Information associated with the response message 700 that is added to the search response cache 526 may include the search request hash of the associated request message 600, the value of the responding peer ID field 712 of the response message 700 (i.e., the peer ID of the responding peer), and an expiration timestamp for the cached response. The expiration timestamp for the cached response may correspond to the resource reservation expiration indicated by the value of the resource reservation time field 716 of the response message 700, or, for example, the minimum of the values if there are multiple such resource reservation times. As for the search request cache 524, the search response cache 526 may collate the added data in multiple ways. The data may be contained in a single cache object/table or be distributed across multiple cache objects/tables. Portions of the search response cache 526 may be optimized for performance reasons, for example, the search response cache 526 may maintain a circular buffer of the last, for example, one hundred search request hashes added to the cache 526.

In these example steps, information associated with the response message 700 is not added to the search response cache 526 unless information regarding the associated peer-to-peer search request was added to the search request cache 524. However, in an embodiment of the invention, information regarding each received response message 700 is added to the search response cache 526. Whether or not step 2412 is performed, following step 2410 (steps 2408, 2410 and 2412 may even be performed in a separate thread of execution), the procedure progresses to steps that forward the received response message 700 towards the originating peer of the associated peer-to-peer search, for example, the steps previously described with reference to FIG. 23.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer-readable medium having thereon computer-executable instructions for performing a method comprising:
formatting a peer-to-peer search request message;
solving a distributed throttling computational puzzle for the peer-to-peer search request message; and
sending the peer-to-peer search request message to at least one receiving peer in a peer-to-peer network.

2. The computer-readable medium of claim 1, wherein the method further comprises:
generating a globally unique identifier for the peer-to-peer search request message; and
formatting the peer-to-peer search request message results in a peer-to-peer search request message format comprising the globally unique identifier for the peer-to-peer search request message.

3. The computer-readable medium of claim 2, wherein:
the method further comprises generating a globally unique identifier for the peer-to-peer search request; and
the peer-to-peer search request message format further comprises the globally unique identifier for the peer-to-peer search request.

4. The computer-readable medium of claim 1, wherein:
the peer-to-peer search request message is sent from a sending peer to said at least one receiving peer; and
each receiving peer is a neighbor of the sending peer in the peer-to-peer network.

5. The computer-readable medium of claim 1, wherein said at least one receiving peer processes the peer-to-peer search request message if the distributed throttling computational puzzle is solved.

6. The computer-readable medium of claim 1, wherein verifying that the distributed throttling computational puzzle is solved is less computationally expensive than solving the distributed throttling computational puzzle.

7. The computer-readable medium of claim 1, wherein solving the distributed throttling computational puzzle for the peer-to-peer search request message comprises transforming the peer-to-peer search request message in combination with the distributed throttling computational puzzle solution with a one way function.

8. The computer-readable medium of claim 1, wherein:
the peer-to-peer search request message is associated with a peer-to-peer search having a peer-to-peer search radius; and
solving the distributed throttling computational puzzle has a computational cost that is a function of the peer-to-peer search radius.

9. The computer-readable medium of claim 1, wherein sending the peer-to-peer search request message to at least one receiving peer in the peer-to-peer network comprises:
selecting a multicast set from said at least one receiving peer, each receiving peer having a peer-to-peer search multicast probability of being included in the multicast set; and
sending the peer-to-peer search request message to each receiving peer in the multicast set.

10. A computer-readable medium having thereon computer-executable instructions for performing a method comprising:
formatting a peer-to-peer search request message;
selecting a multicast set from at least one neighboring peer of a sending peer, each neighboring peer of the sending peer having a peer-to-peer search multicast probability of being included in the multicast set, and the peer-to-peer search multicast probability is a function comprising the number of neighboring peers of the sending peer; and
sending the peer-to-peer search request message to each neighboring peer of the sending peer in the multicast set.

11. The computer-readable medium of claim 10, wherein selecting the multicast set comprises randomly selecting the multicast set.

12. The computer-readable medium of claim 11, wherein selecting the multicast set comprises:
generating a random number for each neighboring peer of the sending peer; and
including the neighboring peer in the multicast set if the pseudo-random number for the neighboring peer is less than the peer-to-peer multicast probability.

13. The computer-readable medium of claim 10, wherein the peer-to-peer search multicast probability of the neighboring peer being included in the multicast set is capable of varying for each neighboring peer.

14. The computer-readable medium of claim 10, wherein:
each peer-to-peer search request message has a peer-to-peer search type;
the sending peer records a frequency with which each neighboring peer of the sending peer responds to each peer-to-peer search type; and
the peer-to-peer search multicast probability of the neighboring peer being included in the multicast set is a function further comprising the frequency with which the neighboring peer responds to the peer-to-peer search type of the peer-to-peer search request message.

15. The computer-readable medium of claim 10, wherein the method further comprises, after a delay, sending the peer-to-peer search request message to each neighboring peer of the sending peer not in the multicast set.

16. The computer-readable medium of claim 10, wherein the method further comprises solving a distributed throttling computational puzzle for the peer-to-peer search request message.

17. A computer-readable medium having thereon computer-executable instructions for performing a method comprising:
parsing a peer-to-peer search request message, the peer-to-peer search request message comprising a plurality of data fields, the plurality of data fields comprising:
a first data field containing a search request message identifier; and
a second data field containing a search request identifier;
discarding the peer-to-peer search request message if the search request message identifier in the first data field of the peer-to-peer search request message is in a search request cache; and
passing at least one data field of the peer-to-peer search request message to at least one registered application if the search request identifier in the second data field of the peer-to-peer search request message is not in the search request cache.

18. The computer-readable medium of claim 17, wherein the method further comprises adding the contents of a plurality of data fields of the peer-to-peer search request message to the search request cache.

19. The computer-readable medium of claim 17, wherein the method further comprises verifying that a distributed throttling computational puzzle for the peer-to-peer search request message is solved.

20. A computer-readable medium having thereon computer-executable instructions for performing a method comprising:
parsing a peer-to-peer search request message;
verifying that a distributed throttling computational puzzle for the peer-to-peer search request message is solved; and
discarding the peer-to-peer search request message if the distributed throttling computational puzzle for the peer-to-peer search request message is not solved.

21. The computer-readable medium of claim 20, wherein verifying that the distributed throttling computational puzzle for the peer-to-peer search request message is solved comprises transforming the peer-to-peer search request message in combination with the distributed throttling computational puzzle solution with a one way function.

22. The computer-readable medium of claim 20, wherein the peer-to-peer search request message comprises at least one data field, said at least one data field comprising a data field containing the distributed throttling computational puzzle solution.

23. The computer-readable medium of claim 20, wherein the method further comprises:
receiving the peer-to-peer search request message from a sending peer; and
discarding the peer-to-peer search request message if the rate of receipt of peer-to-peer search request messages from the sending peer exceeds a maximum peer-to-peer search request rate.

24. A computer-readable medium having thereon computer-executable instructions for performing a method comprising:
updating a peer-to-peer routing path of a peer-to-peer search request message to include a forwarding peer;
determining that a forwarding condition is true for each neighboring peer of the forwarding peer in a peer-to-peer network, the forwarding condition comprising that the neighboring peer is not in the peer-to-peer routing path of the peer-to-peer search request message; and
forwarding the peer-to-peer search request message to the neighboring peer if the forwarding condition is true for the neighboring peer.

25. The computer-readable medium of claim 24, wherein the forwarding condition comprises:
that the neighboring peer is not in the peer-to-peer routing path of the peer-to-peer search request message; and
that the neighboring peer did not send a duplicate of the peer-to-peer search request message to the forwarding peer.

26. The computer-readable medium of claim 25, wherein:
the peer-to-peer search request message has a peer-to-peer search request message identifier; and
the neighboring peer did send the duplicate of the peer-to-peer search request message to the forwarding peer if a search request cache contains the peer-to-peer search request message identifier of the peer-to-peer search request message.

27. The computer-readable medium of claim 24, wherein the forwarding condition comprises:
that the neighboring peer is not in the peer-to-peer routing path of the peer-to-peer search request message; and
a random determination with a peer-to-peer search multicast probability.

28. A computer-readable medium having thereon computer-executable instructions for performing a method comprising:
formatting a peer-to-peer search response message in response to a peer-to-peer search request message, the peer-to-peer search request message having a peer-to-peer routing path, the peer-to-peer routing path listing, in order, at least one peer in a peer-to-peer network traversed by the peer-to-peer search request message, the peer-to-peer routing path listing beginning with an originating peer of the peer-to-peer search request message; and
sending, from a responding peer, the peer-to-peer search response message to the first peer in the peer-to-peer routing path that is a neighboring peer of the responding peer.

29. A computer-readable medium having thereon computer-executable instructions for performing a method comprising:
parsing a peer-to-peer search response message sent in response to a peer-to-peer search request message, the peer-to-peer search response message having a peer-to-peer request routing path, the peer-to-peer request routing path listing, in order, at least one peer in a peer-to-peer network traversed by the peer-to-peer search request message, the peer-to-peer routing path listing beginning with an originating peer of the peer-to-peer search request message; and
forwarding, from a forwarding peer, the peer-to-peer search response message to the first peer in the peer-to-peer request routing path that is a neighboring peer of the forwarding peer.

30. A computerized system, comprising a search message filter module configured to, at least, discard an incoming peer-to-peer search request message if the incoming peer-to-peer search request message does not include a valid solution to a distributed throttling computational puzzle for the incoming peer-to-peer search request message.

31. The computerized system of claim 30, further comprising:
a search request cache configured to, at least, cache information regarding incoming peer-to-peer search request messages;
wherein the incoming peer-to-peer search request message includes a search request message identifier; and
wherein the search message filter module is further configured to, at least, discard the incoming peer-to-peer search request message if the search request cache contains the search request message identifier of the incoming peer-to-peer search request message.

32. The computerized system of claim 31, further comprising:
an application peer-to-peer search registry configured to, at least, pass incoming peer-to-peer search requests to registered applications;
wherein the incoming peer-to-peer search request message includes a search request identifier; and
wherein the search message filter module is further configured to, at least, pass the incoming peer-to-peer search request message to the application peer-to-peer search registry if the search request cache does not contain the search request identifier of the incoming peer-to-peer search request message.

33. The computerized system of claim 30, further comprising a forward search request module configured to, at least:
select a multicast set from at least one neighboring peer of a forwarding peer, each neighboring peer of the forwarding peer having a peer-to-peer search multicast probability of being included in the multicast set; and
forwarding the incoming peer-to-peer search request message to each neighboring peer of the forwarding peer in the multicast set.

34. The computerized system of claim 30, further comprising:
a forward search response module configured to, at least, forward a peer-to-peer search response message from a forwarding peer to the first peer in a peer-to-peer request routing path that is a neighboring peer of the forwarding peer; and
wherein the peer-to-peer search response message was sent to the forwarding peer in response to a peer-to-peer search request message, and the peer-to-peer request routing path contains, in order, at least one peer in a peer-to-peer network traversed by the peer-to-peer search request message, beginning with an originating peer of the peer-to-peer search request message.
